(19) United States
(12) Patent Application Publication
(10) Pub. No.: US 2026/0064124 A1
(43) Pub. Date: Mar. 5, 2026

(54) ADJUSTED ENVIRONMENT NAVIGATION BASED ON STAIR DETERMINATION

(71) Applicant: Boston Dynamics, Inc., Waltham, MA (US)

(72) Inventor: Eric Cary Whitman, Arlington, MA (US)

(21) Appl. No.: 19/310,283

(22) Filed: Aug. 26, 2025

Related U.S. Application Data
(60) Provisional application No. 63/687,528, filed on Aug. 27, 2024.

(51) Int. Cl. G05D 1/435; B62D 57/032; G05B 19/4155; G05D 109/12

(52) U.S. Cl. CPC G05D 1/435; G05B 19/4155; B62D 57/032; G05B 2219/40506; G05D 2109/12

(57) ABSTRACT

Systems and methods are described for mapping and traversal of a set of stairs. A system can obtain a map of an environment. The system can determine that the environment includes a set of stairs based on the map. For example, the map may indicate the presence of the set of stairs within the environment. For mapping the set of stairs, the system can instruct performance of a stair mapping maneuver based on the determination that the environment includes the set of stairs. Based on the performance of the stair mapping maneuver, the system can map the set of stairs. The system can instruct traversal of the set of stairs by a robot based on the mapping of the set of stairs.

### CROSS REFERENCE TO RELATED APPLICATION

This U.S. patent application claims priority under 35 U.S.C. § 119 (e) to U.S. Provisional Application No. 63/687528, filed Aug. 27, 2024, which is considered part of the disclosure of this application and is hereby incorporated by reference in its entirety.

### TECHNICAL FIELD

This disclosure relates generally to robotics, and more specifically, to systems, methods, and apparatus, including computer programs, for navigation of one or more objects, entities, obstacles, and/or structures.

### BACKGROUND

Robotic devices can autonomously or semi-autonomously navigate environments to perform a variety of tasks or functions. The environments may include one or more objects, entities, obstacles, and/or structures (e.g., a set of stairs) for navigation by the robotic devices. As robotic devices become more prevalent and the environments become more diverse, there is a need to map the one or more objects, entities, obstacles, and/or structures prior to navigation of the one or more objects, entities, obstacles, and/or structures.

### SUMMARY

An aspect of the present disclosure provides a method. The method may include obtaining, by data processing hardware of a robot, a map of an environment of the robot. The method may further include determining, by the data processing hardware, based on the map, that the environment includes a set of stairs. The method may further include instructing, by the data processing hardware, performance of a stair mapping maneuver by the robot based on determining that the environment includes the set of stairs. The method may further include obtaining, by the data processing hardware, first sensor data based on the performance of the stair mapping maneuver. The method may further include mapping, by the data processing hardware, the set of stairs based on the first sensor data. The method may further include instructing, by the data processing hardware, traversal of the set of stairs by the robot based on mapping the set of stairs.

In various embodiments, instructing the performance of the stair mapping maneuver may include instructing adjustment of a field of view of the robot.

In various embodiments, instructing the performance of the stair mapping maneuver may include instructing movement by the robot to a location within the environment.

In various embodiments, instructing the performance of the stair mapping maneuver may include identifying a location within the environment associated with the set of stairs based on the map. Instructing the performance of the stair mapping maneuver may further include instructing movement by the robot to the location.

In various embodiments, instructing the performance of the stair mapping maneuver may include instructing movement by the robot to a location within the environment. Instructing the performance of the stair mapping maneuver may further include instructing adjustment of one or more of an orientation of the robot, a position of the robot, or a pose of the robot based on instructing movement by the robot to the location within the environment.

In various embodiments, instructing the performance of the stair mapping maneuver may include instructing movement by the robot to a bottom of the set of stairs.

In various embodiments, instructing the performance of the stair mapping maneuver may include instructing movement by the robot to a top of the set of stairs.

In various embodiments, instructing the performance of the stair mapping maneuver may include instructing movement by the robot to a landing of the set of stairs.

In various embodiments, instructing the performance of the stair mapping maneuver may include determining an orientation of the robot with respect to the set of stairs. Instructing the performance of the stair mapping maneuver may further include instructing the performance of the stair mapping maneuver based on the orientation of the robot with respect to the set of stairs.

In various embodiments, instructing the performance of the stair mapping maneuver may include determining a location within the environment to view the set of stairs. Instructing the performance of the stair mapping maneuver may further include instructing movement by the robot to the location.

In various embodiments, instructing the performance of the stair mapping maneuver may include determining, using second sensor data associated with the environment, a location within the environment to view the set of stairs. Instructing the performance of the stair mapping maneuver may further include instructing movement by the robot to the location.

In various embodiments, instructing the performance of the stair mapping maneuver may include predicting, using second sensor data associated with the environment, a field of view of a sensor at a location within the environment includes the set of stairs. Instructing the performance of the stair mapping maneuver may further include instructing movement by the robot to the location.

In various embodiments, instructing the performance of the stair mapping maneuver may include determining, using second sensor data associated with the environment, a location within the environment to view the set of stairs. Instructing the performance of the stair mapping maneuver may further include instructing movement by the robot to the location. Obtaining the first sensor data may include obtaining the first sensor data based on the movement by the robot to the location.

In various embodiments, instructing the performance of the stair mapping maneuver may include determining, using second sensor data associated with the environment, a location within the environment to view the set of stairs. Instructing the performance of the stair mapping maneuver may further include instructing movement by the robot to the location. Instructing the performance of the stair mapping maneuver may further include verifying the movement by the robot to the location. Obtaining the first sensor data may include obtaining the first sensor data based on verifying the movement by the robot to the location.

In various embodiments, instructing the performance of the stair mapping maneuver may include determining, using second sensor data associated with the environment, a location within the environment to view the set of stairs. Instructing the performance of the stair mapping maneuver may further include instructing movement by the robot to the location. Obtaining the first sensor data may include obtaining the first sensor data based on instructing movement by the robot to the location.

In various embodiments, instructing the performance of the stair mapping maneuver may include instructing adjustment of a pose of the robot.

In various embodiments, instructing the performance of the stair mapping maneuver may include instructing adjustment of an orientation of the robot.

In various embodiments, instructing the performance of the stair mapping maneuver may include instructing adjustment of a position of the robot.

In various embodiments, instructing the performance of the stair mapping maneuver may include determining, using second sensor data associated with the environment, one or more of a pose of the robot, a position of the robot, or an orientation of the robot. Instructing the performance of the stair mapping maneuver may further include instructing adjustment of the robot based on determining the one or more of the pose, the position, or the orientation. Obtaining the first sensor data may include obtaining the first sensor data based on instructing adjustment of the robot.

In various embodiments, instructing the performance of the stair mapping maneuver may include instructing movement of a leg of the robot.

In various embodiments, instructing the performance of the stair mapping maneuver may include instructing movement of a leg of the robot. Instructing the performance of the stair mapping maneuver may further include determining that the leg contacts a portion of the set of stairs.

In various embodiments, instructing the performance of the stair mapping maneuver may include instructing movement of a leg of the robot. Instructing the performance of the stair mapping maneuver may further include obtaining second sensor data. Instructing the performance of the stair mapping maneuver may further include determining that the leg contacts a portion of the set of stairs based on the second sensor data.

In various embodiments, instructing the performance of the stair mapping maneuver may include instructing movement of a leg of the robot. Instructing the performance of the stair mapping maneuver may further include obtaining second sensor data. Instructing the performance of the stair mapping maneuver may further include determining that the leg contacts a portion of the set of stairs based on the second sensor data. Mapping the set of stairs may be further based on the second sensor data.

In various embodiments, instructing the performance of the stair mapping maneuver may include adjusting a speed of the robot.

In various embodiments, instructing the performance of the stair mapping maneuver may include adjusting a speed of the robot to 0.35 meters per second.

In various embodiments, instructing the performance of the stair mapping maneuver may include adjusting a gait of the robot.

In various embodiments, instructing the performance of the stair mapping maneuver may include adjusting a swing of a leg of the robot.

In various embodiments, instructing the performance of the stair mapping maneuver may include instructing a deceleration of the robot.

In various embodiments, instructing the performance of the stair mapping maneuver may include adjusting a deceleration of the robot to 2 meters per second squared.

In various embodiments, instructing the performance of the stair mapping maneuver may include adjusting a stair mapping maneuver for performance by the robot from a first stair mapping maneuver to a second stair mapping maneuver.

In various embodiments, instructing the performance of the stair mapping maneuver may include instructing iterative performance of a hierarchical plurality of stair mapping maneuvers.

In various embodiments, instructing the performance of the stair mapping maneuver may include adjusting a stair mapping maneuver for performance by the robot from a first stair mapping maneuver to a second stair mapping maneuver. A first portion of the set of stairs may be occluded with respect to a field of view of a sensor of the robot based on performance of the first stair mapping maneuver. A second portion of the set of stairs may be occluded with respect to the field of view based on performance of the second stair mapping maneuver. A first portion of the first sensor data may be based on the performance of the first stair mapping maneuver and a second portion of the first sensor data may be based on the performance of the second stair mapping maneuver.

In various embodiments, instructing the performance of the stair mapping maneuver may include adjusting a gait of the robot from a first gait to a second gait. The method may further include adjusting the gait of the robot from the second gait to a third gait based on mapping the set of stairs.

In various embodiments, the method may further include adjusting a manner of navigation of the robot based on mapping the set of stairs. Instructing traversal of the set of stairs may include instructing traversal of the set of stairs by the robot based on the adjusted manner of navigation.

In various embodiments, instructing the performance of the stair mapping maneuver may include instructing the performance of a first stair mapping maneuver. Instructing the performance of the stair mapping maneuver may further include determining that at least a portion of the set of stairs are occluded with respect to a field of view of a sensor of the robot based on the first stair mapping maneuver. Instructing the performance of the stair mapping maneuver may further include instructing performance of a second stair mapping maneuver based on determining that the at least a portion of the set of stairs are occluded.

In various embodiments, instructing the performance of the stair mapping maneuver may include instructing performance of a first stair mapping maneuver. Instructing the performance of the stair mapping maneuver may further include determining that a field of view of a sensor of the robot based on the first stair mapping maneuver does not include a portion of the set of stairs. Instructing the performance of the stair mapping maneuver may further include instructing performance of a second stair mapping maneuver based on determining that the field of view does not include the portion of the set of stairs.

In various embodiments, instructing the performance of the stair mapping maneuver may include instructing performance of a first stair mapping maneuver. The method may further include mapping a first portion of the set of stairs based on the performance of the first stair mapping maneuver. The method may further include instructing performance of a second stair mapping maneuver based on mapping the first portion of the set of stairs. The method may further include mapping a second portion of the set of stairs based on the performance of the second stair mapping maneuver. Different portions of the set of stairs may be mapped based on the performance of the first stair mapping maneuver and the performance of the second stair mapping maneuver.

In various embodiments, mapping the set of stairs may include mapping the set of stairs to the first sensor data.

In various embodiments, mapping the set of stairs may include generating a stair model. The stair model may map the set of stairs to the first sensor data.

In various embodiments, mapping the set of stairs may include generating a stair model. Mapping the set of stairs may further include determining the stair model maps a riser of the set of stairs to the first sensor data. Instructing traversal of the set of stairs may be based on determining the stair model maps the riser of the set of stairs to the first sensor data.

In various embodiments, the method may further include generating a first stair model based on performance of a first stair mapping maneuver. The first stair model may map a first portion of the set of stairs to the first sensor data. The method may further include determining that the first stair model does not satisfy a threshold. The method may further include adjusting a stair mapping maneuver for performance by the robot from the first stair mapping maneuver to a second stair mapping maneuver based on determining that the first stair model does not satisfy the threshold. Mapping the set of stairs may include generating a second stair model based on performance of the second stair mapping maneuver. The second stair model may map a second portion of the set of stairs to second sensor data. Mapping the set of stairs may further include determining that the second stair model satisfies the threshold.

In various embodiments, the method may further include generating a first stair model based on performance of a first stair mapping maneuver. The first stair model may map a first portion of the set of stairs to the first sensor data. The method may further include determining that the first stair model does not map a second portion of the set of stairs to the first sensor data. The method may further include adjusting a stair mapping maneuver for performance by the robot from the first stair mapping maneuver to a second stair mapping maneuver based on determining that the first stair model does not map the second portion of the set of stairs to the first sensor data. Mapping the set of stairs may include generating a second stair model based on performance of the second stair mapping maneuver. The second stair model may map the second portion of the set of stairs to second sensor data.

In various embodiments, mapping the set of stairs may include mapping a riser of the set of stairs.

In various embodiments, mapping the set of stairs may include mapping a landing of the set of stairs to the first sensor data.

In various embodiments, mapping the set of stairs may include mapping a tread of the set of stairs.

In various embodiments, mapping the set of stairs may include mapping the set of stairs based on the performance of the stair mapping maneuver.

In various embodiments, mapping the set of stairs may include mapping the set of stairs based on the performance of the stair mapping maneuver. The method may further include verifying that a particular portion of the set of stairs is mapped.

In various embodiments, mapping the set of stairs may include mapping the set of stairs based on the performance of the stair mapping maneuver. The method may further include determining a confidence metric associated with mapping the set of stairs. The method may further include verifying that the confidence metric satisfies a threshold.

In various embodiments, mapping the set of stairs may include generating a stair model based on the performance of the stair mapping maneuver. The method may further include determining a threshold associated with the set of stairs. The method may further include verifying that the stair model satisfies a threshold.

In various embodiments, mapping the set of stairs may include generating a stair model based on the performance of the stair mapping maneuver. The method may further include determining one or more criteria associated with the set of stairs. The method may further include verifying that the stair model satisfies the one or more criteria. Instructing traversal of the set of stairs may be further based on verifying that the stair model satisfies the one or more criteria.

In various embodiments, mapping the set of stairs may include generating a stair model. Mapping the set of stairs may further include verifying that the stair model satisfies a threshold. Instructing traversal of the set of stairs may be based on verifying that the stair model satisfies a threshold.

In various embodiments, the method may further include identifying a mission associated with the robot. The method may further include determining that the mission is associated with the set of stairs. Instructing the performance of the stair mapping maneuver may include instructing the performance of the stair mapping maneuver further based on determining that the mission is associated with the set of stairs.

In various embodiments, the method may further include identifying a navigation route associated with the robot. The method may further include determining that the navigation route is associated with the set of stairs. Instructing the performance of the stair mapping maneuver may include instructing the performance of the stair mapping maneuver further based on determining that the navigation route is associated with the set of stairs.

In various embodiments, the method may further include obtaining second sensor data from a sensor of the robot. Instructing the performance of the stair mapping maneuver may include instructing the performance of the stair mapping maneuver further based on the second sensor data.

In various embodiments, obtaining the first sensor data may include obtaining the first sensor data from a sensor of the robot.

In various embodiments, obtaining the first sensor data may include obtaining the first sensor data from a sensor of the robot. The first sensor data may include one or more of image data or pressure data.

In various embodiments, the method may further include selecting the stair mapping maneuver from a set of stair mapping maneuvers based on a cost function.

In various embodiments, the method may further include selecting the stair mapping maneuver from a set of stair mapping maneuvers based on a cost function. Each stair mapping maneuver of the set of stair mapping maneuvers may indicate one or more of a respective orientation or a respective position.

In various embodiments, instructing the performance of the stair mapping maneuver may include instructing a deviation by the robot from a navigation route of the robot. The navigation route may indicate a set of route waypoints connected using a set of route edges.

In various embodiments, instructing the performance of the stair mapping maneuver may include instructing a deviation by the robot from a route edge connecting a first route waypoint and a second route waypoint.

In various embodiments, the map may indicate the set of stairs.

In various embodiments, the method may further include obtaining, from a computing system, the map.

In various embodiments, the method may further include generating the map.

In various embodiments, the robot comprises a legged robot.

According to various embodiments of the present disclosure, a system may include data processing hardware and memory in communication with the data processing hardware. The memory may store instructions that when executed on the data processing hardware cause the data processing hardware to obtain a map of an environment of a robot. Execution of the instructions may further cause the data processing hardware to determine, based on the map, that the environment includes a set of stairs. Execution of the instructions may further cause the data processing hardware to instruct performance of a stair mapping maneuver by the robot based on determining that the environment includes the set of stairs. Execution of the instructions may further cause the data processing hardware to obtain first sensor data based on the performance of the stair mapping maneuver. Execution of the instructions may further cause the data processing hardware to map the set of stairs based on the first sensor data. Execution of the instructions may further cause the data processing hardware to instruct traversal of the set of stairs by the robot based on mapping the set of stairs.

In various embodiments, the system may further include any combination of the features discussed herein.

According to various embodiments of the present disclosure, a robot may include data processing hardware and memory in communication with the data processing hardware. The memory may store instructions that when executed on the data processing hardware cause the data processing hardware to obtain a map of an environment of the robot. Execution of the instructions may further cause the data processing hardware to determine, based on the map, that the environment includes a set of stairs. Execution of the instructions may further cause the data processing hardware to instruct performance of a stair mapping maneuver by the robot based on determining that the environment includes the set of stairs. Execution of the instructions may further cause the data processing hardware to obtain first sensor data based on the performance of the stair mapping maneuver. Execution of the instructions may further cause the data processing hardware to map the set of stairs based on the first sensor data. Execution of the instructions may further cause the data processing hardware to instruct traversal of the set of stairs by the robot based on mapping the set of stairs.

In various embodiments, the robot may further include any combination of the features discussed herein.

According to various embodiments of the present disclosure, a method may include obtaining, by data processing hardware of a robot, a map of an environment of the robot. The method may further include determining, by the data processing hardware, based on the map, that the environment includes a set of stairs. The method may further include obtaining, by the data processing hardware, sensor data associated with a sensor of the robot. The method may further include verifying, by the data processing hardware, that the sensor data indicates the set of stairs based on determining that the environment includes the set of stairs. The method may further include instructing, by the data processing hardware, traversal of the set of stairs by the robot based on verifying that the sensor data indicates the set of stairs.

In various embodiments, the method may further include any combination of the features discussed herein.

According to various embodiments of the present disclosure, a method may include obtaining, by data processing hardware of a robot, a map of an environment of the robot. The method may further include determining, by the data processing hardware, based on the map, that the environment includes a set of stairs. The method may further include adjusting, by the data processing hardware, a stair mapping maneuver for performance by the robot from a first stair mapping maneuver to a second stair mapping maneuver based on determining that the environment includes the set of stairs. The method may further include determining, by the data processing hardware, that at least a portion of the set of stairs are occluded based on the stair mapping maneuver. The method may further include adjusting, by the data processing hardware, the stair mapping maneuver for performance by the robot from the second stair mapping maneuver to a third stair mapping maneuver based on determining that at least a portion of the set of stairs are occluded. The method may further include instructing, by the data processing hardware, traversal of the set of stairs by the robot based on performance of the third stair mapping maneuver.

In various embodiments, the method may further include any combination of the features discussed herein.

According to various embodiments of the present disclosure, a method may include obtaining, by data processing hardware of a robot, a map of an environment of the robot. The method may further include determining, by the data processing hardware, based on the map, that the environment includes a set of stairs. The method may further include instructing, by the data processing hardware, navigation by the robot to a portion of the environment based on determining that the environment includes the set of stairs. The method may further include obtaining, by the data processing hardware, sensor data based on instructing the navigation by the robot to the portion of the environment. The method may further include instructing, by the data processing hardware, traversal of the set of stairs based on the sensor data.

In various embodiments, the method may further include any combination of the features discussed herein.

According to various embodiments of the present disclosure, a method may include obtaining, by data processing hardware of a robot, a map of an environment of the robot. The method may further include determining, by the data processing hardware, based on the map, that the environment includes a set of stairs. The method may further include determining, by the data processing hardware, that at least a portion of the set of stairs are occluded based on a stair mapping maneuver of the robot. The method may further include generating, by the data processing hardware, an alert based on determining that at least a portion of the set of stairs are occluded. The method may further include routing, by the data processing hardware, the alert to a computing system.

In various embodiments, the method may further include any combination of the features discussed herein.

According to various embodiments of the present disclosure, a method may include obtaining, by data processing hardware of a robot, a map of an environment of the robot. The method may further include determining, by the data processing hardware, based on the map, that the environment includes a set of stairs. The method may further include determining, by the data processing hardware, that at least a portion of the set of stairs are occluded. The method may further include adjusting, by the data processing hardware, a stair mapping maneuver for performance by the robot based on determining that at least a portion of the set of stairs are occluded. The method may further include instructing, by the data processing hardware, traversal of the set of stairs based on the adjusted stair mapping maneuver.

In various embodiments, the method may further include any combination of the features discussed herein.

According to various embodiments of the present disclosure, a system may include data processing hardware and memory in communication with the data processing hardware. The memory may store instructions that when executed on the data processing hardware cause the data processing hardware to perform any combination of the features discussed herein.

According to various embodiments of the present disclosure, a robot may include at least one sensor, at least two legs, data processing hardware, and memory in communication with the data processing hardware. The memory may store instructions that when executed on the data processing hardware cause the data processing hardware to perform any combination of the features discussed herein.

### DESCRIPTION OF DRAWINGS

FIG. 1A is a schematic view of an example robot for navigating within an environment that includes a set of stairs.

FIG. 1B is a schematic view of an example robot in communication with a remote system and a user computing device.

FIG. 1C is a schematic view of an example navigation system of the robot of FIG. 1A.

FIG. 2A is a schematic view of an example stair tracker of the robot of FIG. 1A.

FIG. 2B is a schematic view of an example stair tracker of the robot of FIG. 1A.

FIG. 3 is a schematic view of the robot of FIG. 1A.

FIG. 4 is a schematic view of an example robot for navigating within an environment that includes a set of stairs.

FIG. 5A is a schematic view of an example robot based on performance of a mapping maneuver.

FIG. 5B is a schematic view of an example robot based on performance of a mapping maneuver.

FIG. 5C is a schematic view of an example robot based on performance of a mapping maneuver.

FIG. 6 is a schematic view of an example robot navigating a set of stairs.

FIG. 7 is a flowchart of an example arrangement of operations for mapping a set of stairs and instructing traversal of the set of stairs.

FIG. 8 is an operation diagram illustrating a data flow for operations for mapping a set of stairs and instructing traversal of the set of stairs.

FIG. 9 is a schematic view of an example computing device that may be used to implement the systems and methods described herein.

Like reference symbols in the various drawings indicate like elements.

### DETAILED DESCRIPTION

Generally described, autonomous and semi-autonomous robots (e.g., mobile robots, legged robots, etc.) can capture data (e.g., robot data, mobile robot data, etc.) associated with the robots. The data may correspond to (e.g., may represent) an environment of a robot. For example, the data may be a two-dimensional representation of a three-dimensional environment of the robot.

A robot can obtain the data (e.g., sensor data) from one or more components of the robot (e.g., sensors). For example, the robot can obtain sensor data from an image sensor, a lidar sensor, a ladar sensor, a radar sensor, pressure sensor, an accelerometer, a battery sensor (e.g., a voltage meter), a speed sensor, a position sensor, an orientation sensor, a pose sensor, a tilt sensor, a clock, and/or any other component of the robot. Further, the sensor data may include image data, lidar data, ladar data, radar data, pressure data, acceleration data, battery data (e.g., voltage data), speed data, position data, orientation data, pose data, tilt data, time data, temperature data, etc. For example, the data may include image data that further includes a plurality of images. It will be understood that while reference may be made herein to sensor data or image data, any data associated with the robot can be utilized.

In some cases, the robot can capture sensor data before, after, and/or during traversal of the environment by the robot. For example, the robot can capture the sensor data as the robot actively traverses the environment.

The robot may map the environment (e.g., using the sensor data) and may localize and navigate within the environment (e.g., using the sensor data) based on mapping the environment. To map the environment, the robot may generate map data (e.g., a map) associated with the environment. For example, the robot may navigate within the environment (e.g., based on an input received via a user computing device), may obtain sensor data (e.g., via one or more sensors) associated with the environment, and, based on the sensor data, the robot may generate a map data (e.g., a graph map, a topological map, etc.).

The map data may include a navigation route. The navigation route may indicate and/or identify two or more route waypoints and/or one or more route edges between the two or more route waypoints (e.g., the one or more route edges may represent paths between respective pairs of the one or more route waypoints).

In some cases, the one or more route waypoints may be associated with (e.g., may indicate) sensor data, location data (e.g., one or more locations within the environment), time data (e.g., one or more time periods), fiducial data (e.g., one or more fiducials), and/or robot data (e.g., pose data of the robot, location data of the robot, orientation data of the robot, position data of the robot, etc.). The one or more route edges may topologically connect a first route waypoint and a second route waypoint of the one or more route waypoints and may define a local transform between a reference frame of the first route waypoint and a reference frame of the second route waypoint.

Using the map data, the robot may traverse (e.g., autonomously) the environment (e.g., using the one or more route waypoints and/or the one or more route edges). For example, the robot may navigate the environment according to a navigation route indicated by the map data. The robot may use first map data (e.g., predefined map data generated during an initial mapping operation) and second map data (e.g., live map data including an obstacle map). For example, the robot may generate the first map data based on an initial navigation of the environment, may store the first map data, and may use the first map data for a subsequent navigation of the environment in addition to second map data generated during the subsequent navigation of the environment. While the first map data may map entities, objects, obstacles, and/or structures in the environment (e.g., an approximate location of the entities, objects, obstacles, and/or structures), as the first map data may be predefined map data and the second map data may be live map data, the second map data may be more accurate as compared to the first map data.

During mapping, localization, and/or navigation within the environment, the robot may map one or more features representing one or more objects, entities, structures, and/or obstacles (e.g., by generating a model of the one or more objects, entities, structures, and/or obstacles). For example, the features may represent, may correspond to, may include, may identify, and/or may indicate the presence of one or more real world obstacles, real world objects, real world entities, real world structures, etc. (e.g., walls, sets of stairs, humans, robots, vehicles, toys, animals, pallets, rocks, etc.).

The one or more objects, entities, structures, and structures may affect the movement of the robot as the robot traverses the environment. For example, the robot may traverse a set of stairs (e.g., one or more stairs) in a different manner (e.g., using a different gait, a different leg swing height, a different body height (e.g., a distance between a body of the robot and a ground surface), a different pose, a different traversal direction, etc.) as compared to traversal of a flat ground surface to avoid an incident (e.g., tripping on the set of stairs, hitting the set of stairs, falling down the set of stairs, etc.) and/or being unable to successfully traverse the set of stairs (e.g., from a first landing of the set of stairs to a second landing of the set of stairs without tripping, falling, hitting the set of stairs, etc.). In another example, the robot may use different placement locations for one or more distal ends (e.g., feet) of one or more legs of the robot for traversing one or more entities, obstacles, structures, and/or objects as compared to traversing other portions of the environment. In some cases, the set of stairs may include a single stair.

The robot may detect one or more obstacles, objects, entities, and/or structures within the environment based on the sensor data. For example, the robot may detect a set of stairs during generation of the map data (e.g., the predefined map data generated during an initial mapping mission). Based on detecting the one or more obstacles, objects, entities, and/or structures, the robot may annotate the map data to indicate a location in the environment associated with the one or more obstacles, objects, entities, and/or structures (e.g., a location in the environment in which the robot detected a set of stairs). For example, the map data may indicate that a set of stairs is located in a particular location of the environment.

The sensor data associated with one or more objects, entities, obstacles, and/or structures (e.g., sensor data associated with a set of stairs) may be of a lesser quality as compared to sensor data associated with other portions of the environment. In one example, the sensor data may not map (e.g., measure) a set of stairs within the environment. For example, the sensor data may not map (e.g., fully map) a set of stairs that includes open riser stairs as a sensor of the robot may obtain particular sensor data associated with an open riser stair which may cause the robot to falsely map the set of stairs (e.g., the robot may attribute an incorrect size, shape, dimension, etc. to the set of stairs). In another example, the sensor data may not map a descending set of stairs (e.g., a set of stairs which the robot is descending) due to the structure and/or lines of a set of stairs (e.g., as viewed from a top of the set of stairs).

To enable the traversal of one or more objects, entities, obstacles, and/or structures that may be associated with sensor data of a lesser quality as compared to sensor data associated with other portions of the environment, the robot may utilize an operational mode configured for the one or more objects, entities, obstacles, and/or structures. For example, based on an annotation in the predefined map data (e.g., indicating a location associated with a set of stairs), the robot may enter (e.g., automatically) an operational mode designed specifically to perceive and traverse the one or more obstacles, objects, entities, and/or structures (e.g., prior to the robot traversing the one or more obstacles, objects, entities, and/or structures). In the example of the one or more obstacles, objects, entities, and/or structures being a set of stairs, the operational mode may be referred to herein as “stairs mode.” The operational mode can include particular settings for the robot that (A) facilitate the perception of nuances of the one or more obstacles, objects, entities, and/or structures, and (B) control aspects of the robot to successfully traverse the one or more obstacles, objects, entities, and/or structures (e.g., around, over, under, etc. the one or more obstacles, objects, entities, and/or structures.

In some cases, the robot may enter the operational mode without prior traversal of the environment by the robot, without generation of the predefined map data, without utilizing the predefined map data, etc. For example, the robot may receive sensor data (e.g., image data), detect a set of stairs within the environment based on the sensor data, and determine a location of the set of stairs within the environment based on the sensor data (e.g., using live map data). The robot may determine that the robot is expected to enter a region (e.g., a safety region) associated with (e.g., around) the one or more obstacles, objects, entities, and/or structures and may enter the operational mode based on determining that the robot is expected to enter the region.

Entering of the operational mode may cause the robot to activate a tracker to detect and track features of the one or more obstacles, objects, entities, and/or structures for traversal of the one or more obstacles, objects, entities, and/or structures. For example, based on entering the stairs mode, the robot may activate a stair tracker of the robot for detecting and tracking features of a set of stairs. In some cases, the robot may activate the tracker prior to entering the operational mode. For example, the robot may enter the operational mode based on the tracker detecting and tracking one or more features of the one or more obstacles, objects, entities, and/or structures.

The robot may utilize the tracker to generate and output a model of the one or more objects, entities, obstacles, and/or structures based on the sensor data. The model may map (e.g., indicate, identify, and/or include) features of the one or more objects, entities, obstacles, and/or structures based on (e.g., to) the sensor data. For example, a model may indicate a set of stairs, a configuration of the set of stairs, a location of the set of stairs, a surface height of the set of stairs, etc. To generate the model, the tracker may include a detector and a detection tracker. The detector may receive the sensor data and may generate a detected feature (e.g., corresponding to one or more features of the one or more objects, entities, obstacles, and/or structures such as one or more corners, edges, treads, risers, walls, etc.). The detection tracker may monitor the detected feature. For example, the detection tracker may monitor the detected and, periodically or aperiodically, update the detected feature (e.g., based on updated sensor data).

The tracker may provide the model to a system of the robot for traversal of the one or more objects, entities, obstacles, and/or structures by the robot (e.g., using the model). For example, the tracker may provide the model to a navigation system of the robot and the navigation system may instruct traversal of the one or more objects, entities, obstacles, and/or structures by the robot using the model.

In some cases, a system of the robot (e.g., a control system, a mapping system, a perception system, etc.) may receive the model from the tracker and one or more maps (e.g., from a perception system of the robot). In some cases, the system may merge at least a portion of the model with at least a portion of the one or more maps to obtain a merged map (or a merged model) and may instruct traversal of the environment (e.g., the set of stairs) using the merged map. In some cases, the system may determine one of the model or a map of the one or more maps and may instruct traversal of the environment (e.g., the set of stairs) using the determined model or map.

The model may map features (e.g., characteristics, dimensions, etc.) of the one or more objects, entities, obstacles, and/or structures (e.g., walls, edges, treads, corners, risers, etc.). For example, the robot may use the model to identify structural features of a set of stairs and, based on the identified structural features, may identify one or more locations to place one or more distal ends of one or more legs of the robot. The robot may instruct navigation based on the model (e.g., using the one or more features of the one or more objects, entities, obstacles, and/or structures as indicated by the model).

The tracker may build (e.g., continuously) the model as the robot navigates the environment (e.g., and the one or more objects, entities, obstacles, and/or structures). For example, the tracker may update a stair model as the robot traverses a set of stairs and obtains additional sensor data based on the traversal of the set of stairs and may provide the updated stair model to the robot for further navigation of the set of stairs.

To use the model, the robot may localize within the environment relative to the one or more objects, entities, obstacles, and/or structures. For example, the robot may obtain sensor data associated with the environment (e.g., from one or more sensors of the robot) and may use the sensor data to localize within the environment. Based on localizing within the environment, the robot may use the model to navigate within the environment.

As discussed herein, a robot may use the model and/or the one or more maps to navigate the environment. However, navigation of the environment according to an incomplete or partial model may be computationally inefficient and/or dangerous. For example, a portion of the one or more objects, entities, obstacles, and/or structures may be obstructed relative to one or more sensors of the robot (e.g., the one or more sensors may be blocked from viewing, at least in part, the one or more objects, entities, obstacles, and/or structures) such that the model is incomplete or partial. In another example, the robot may be located relative to a set of stairs (e.g., at a top of a set of descending stairs) such that sensor data obtained by one or more sensors of the robot does not include the set of stairs (e.g., a field of view of the one or more sensors does not include at least a portion of the set of stairs). Navigation of a set of stairs using a stair model that does not map (e.g., measure, describe, etc.) all or a portion of the features of the set of stairs may be disadvantageous. While the robot may adjust a manner of navigation of the robot to navigate the one or more objects, entities, obstacles, and/or structures (e.g., by adjusting a pose of the robot, adjusting a gait of the robot, etc. that the robot uses to navigate the one or more objects, entities, obstacles, and/or structures) based on detecting the one or more objects, entities, obstacles, and/or structures, using the adjusted manner of navigation to navigate the one or more objects, entities, obstacles, and/or structures according to an incomplete or partial model may be computationally inefficient and/or dangerous. Further, navigation of an environment according to predefined map data without utilizing live map data (e.g., a local obstacle map) may be dangerous as a location of an object, entity, structure, and/or obstacle may be changed between generated of the predefined map data and the live map data.

In some cases, a user may attempt to manually identify and/or define one or more objects, entities, obstacles, and/or structures. However, such a manual process may not be possible as a robot may navigate large environments and the environments may include different entities, obstacles, structures, and/or objects. Further, the entities, obstacles, structures, and/or objects may be associated with numerous features such that it may not be possible to manually identify all or a portion of the features in an efficient manner. Such a manual process may cause issues and/or inefficiencies (e.g., inefficiencies in mission performance) as an inaccurate and/or incomplete model of the entities, obstacles, structures, and/or objects may cause a robot to be unable to navigate (e.g., successfully) the entities, obstacles, structures, and/or objects. Further, such a manual process may be resource, time intensive, and inefficient based on the amount of data associated with a robot.

As components (e.g., mobile robots) proliferate, there is an increased demand for robots to navigate different entities, obstacles, structures, and/or objects. Specifically, there is an increased demand for robots to dynamically navigate a set of stairs (e.g., successfully). The present disclosure provides systems and methods that enable an increase in the success rate and the efficiency in the navigation of entities, obstacles, structures, and/or objects (e.g., a set of stairs).

To navigate the entities, obstacles, structures, and/or objects, the methods and apparatus described herein enable a system to verify that the model maps and/or indicates the entities, obstacles, structures, and/or objects. For example, the system can obtain the model from a tracker and verify that the model maps a full entity, obstacle, structure, and/or object. Further, the system may instruct performance of a stair mapping maneuver by the robot during generation of the model and prior to traversal of the entities, obstacles, structures, and/or objects. For example, the system may instruct performance of a stair mapping maneuver by the robot to enable generation of the model (and mapping of the entities, obstacles, structures, and/or objects) based on the performance of the stair mapping maneuver.

The computing system can obtain map data (e.g., predefined map data). For example, the computing system may generate the map data based on a first representation of the environment. As discussed herein, the map data may include an annotation indicating that the environment includes one or more entities, obstacles, structures, and/or objects. For example, the map data may indicate that the environment includes a set of stairs.

The computing system can obtain mission data (e.g., indicating a mission associated with a robot). For example, the mission data may indicate a navigation route of the robot to navigate through an environment.

The computing system may determine that the map data and/or the mission data is associated with (e.g., indicates, includes, identifies, etc.) one or more entities, obstacles, structures, and/or objects.

In some cases, to determine that the map data and/or the mission data is associated with one or more entities, obstacles, structures, and/or objects, the computing system may determine, based on the map data and/or the mission data, that a location of the robot satisfies (e.g., is greater than, is less than, is within, is equal to or matches, etc.) a threshold (e.g., a threshold value, a threshold range, etc.) or a set of two or more thresholds associated with the one or more entities, obstacles, structures, and/or objects. For example, the computing system may determine that a location of the robot is within a threshold distance of a set of stairs.

In some cases, to determine that the map data and/or the mission data is associated with one or more entities, obstacles, structures, and/or objects, the computing system may predict that the location of the robot will satisfy the threshold within a particular time period (e.g., based on a navigation route indicated by the mission data). For example, the computing system may determine that the location of the robot will be within a threshold distance of a set of stairs based on a navigation route (e.g., a planned navigation route) of the robot. In another example, the computing system may determine, based on the mission data, that the navigation route includes and/or indicates traversal of the set of stairs.

In some cases, to determine that the map data and/or the mission data is associated with one or more entities, obstacles, structures, and/or objects, computing system may determine that a location of the robot is within an environment that includes one or more entities, obstacles, structures, and/or objects (e.g., based on the map data). For example, the computing system may determine that the robot is located within an environment that includes a set of stairs.

Based on determining that the map data and/or the mission data is associated with one or more entities, obstacles, structures, and/or objects, the computing system may obtain second map data (e.g., live map data). For example, the second map data may be real time map data indicating a local obstacle map of the robot. For example, the computing system may generate the map data based on a first representation of the environment (e.g., during a first time period) and may generate the second map data based on a second representation of the environment (e.g., during a second time period). As the map data and the second map data may be generated during separate, different time periods, separate, different missions, etc., the map data and the second map data may indicate different obstacles, structures, objects, and/or entities and/or different locations of the obstacles, structures, objects, and/or entities.

The second map data may include and/or may indicate a model associated with the one or more entities, obstacles, structures, or objects. The computing system may review the model using one or more criteria (e.g., indicating a threshold). For example, the criteria may indicate a threshold clarity metric (e.g., a clarity of the model), a threshold confidence metric (e.g., a confidence that the model represents the set of stairs), a threshold feature metric (e.g., a particular feature), a threshold quality metric (e.g., a quality of the model), a threshold precision metric (e.g., a precision of the model), a threshold accuracy metric (e.g., an accuracy of the model), etc. The computing system may review and validate (or invalidate) the model using the one or more criteria to determine if the model satisfies the one or more criteria.

In some cases, the computing system may review the model and determine if the model maps a first riser (e.g., an initial riser) of the set of stairs. If the computing system determines the model does not map the first riser, the computing system may further review the model and determine if the model maps a second riser (e.g., a subsequent riser) of the set of stairs). The computing system may determine that the model satisfies the one or more criteria if the model maps the first riser or the second riser. If the computing system does not map the first riser or the second riser, the computing system may instruct performance of one or more mapping maneuvers.

Based on determining that the model does not satisfy the one or more criteria and based on determining that the map data and/or the mission data is associated with one or more entities, obstacles, structures, and/or objects, the computing system may instruct performance of a mapping maneuver (e.g., a stair mapping maneuver) by the robot. For example, as the robot may not have a movable neck, the computing system may instruct movement of the robot to a location within environment (e.g., using one or more legs of the robot) to adjust a position of one or more sensors of the robot (e.g., located on a body of the robot).

The mapping maneuver may include an adjustment to a manner of navigation of the robot (e.g., adjusting a gait, a speed, a deceleration, a pose, a body height, a leg swing height, etc. of the robot for navigation). For example, the mapping maneuver may include navigation to a location within an environment. In some cases, the mapping maneuver may include or more of navigation by the robot to a location within the environment (e.g., a location associated with the one or more entities, obstacles, structures, and/or objects), adjustment of a pose (e.g., one or more joint angles), orientation, position, etc. of the robot (e.g., to adjust a view of the robot with respect to the one or more entities, obstacles, structures, and/or objects), movement of an appendage (e.g., an arm or a leg) of the robot (e.g., to cause the appendage to contact the one or more entities, obstacles, structures, and/or objects such that the computing system can use the contact data to determine a location, size, shape, etc. of the one or more entities, obstacles, structures, and/or objects), adjustment of a gait of the robot, adjustment of a leg swing height of the robot, adjustment of a body height, adjustment of a criterion used to validate the stair model (e.g., adjusting a criterion from validating based on a mapping of a first riser to validating based on a second riser), etc.

In some cases, the computing system may select the mapping maneuver from a plurality of mapping maneuvers based on a hierarchical plurality of mapping maneuvers (e.g., a hierarchical plurality of stair mapping maneuvers). The hierarchical plurality of mapping maneuvers may include and/or may indicate an order of performance of the plurality of mapping maneuvers (e.g., a priority). For example, the order may indicate to first attempt to map the set of stairs based on mapping a first riser of the set of stairs, second attempt to map the set of stairs based on mapping a second riser of the set of stairs, third attempt to map the set of stairs based on implementing a cautious gait, etc. In some cases, the computing system may receive an input (e.g., from a user computing device) defining the hierarchical plurality of mapping maneuvers.

In some cases, the computing system may combine mapping maneuvers. For example, the computing system may instruct performance of a first mapping maneuver (e.g., navigation of the robot to a location) and a second mapping maneuver (e.g., adjustment of a pose of the robot). In some cases, the computing system may iteratively implement one or more mapping maneuvers. For example, the computing system may iteratively instruct performance of a first mapping maneuver (e.g., navigation of the robot to a first location during a first time period) and a second mapping maneuver (e.g., navigation of the robot to a second location during a second time period).

The computing system may determine the mapping maneuver for performance based on the one or more entities, obstacles, structures, and/or objects, the robot, and/or the environment. For example, the computing system may determine that one or more particular sensors (e.g., sensors on a front portion of the robot) are to be used to obtain sensor data for mapping the one or more entities, obstacles, structures, and/or objects and may determine the mapping maneuver for performance such that the one or more particular sensors are oriented towards the one or more entities, obstacles, structures, and/or objects.

Based on performance of the mapping maneuver by the robot, the computing system may obtain sensor data. For example, the computing system may instruct performance of a mapping maneuver (e.g., navigation of the robot to a first location during a first time period) and may obtain sensor data (e.g., associated with the first location) based on performance of the mapping maneuver. The computing system may obtain and/or generate second map data (e.g., live map data) based on the sensor data. For example, the second map data may include a model.

In some cases, the computing system may construct and/or update a model associated with the one or more entities, obstacles, structures, and/or objects (e.g., an environment model) based on the obtained sensor data. For example, the computing system may instruct performance of a mapping maneuver, may obtain sensor data based on the performance of the mapping maneuver, and may update the model based on the obtained sensor data. In some cases, the computing system may obtain an updated model (e.g., periodically or aperiodically) according to the obtained sensor data.

In some cases, as discussed herein, the computing system may compare the updated model and the criteria to verify whether the updated model satisfies the criteria (e.g., whether the updated model maps the one or more entities, obstacles, structures, and/or objects). For example, the computing system may verify that the model maps particular features and/or particular portions (e.g., a first riser, a second riser, etc.) of the one or more entities, obstacles, structures, and/or objects, that a confidence metric, clarity metric, precision metric, accuracy metric, quality metric, etc. satisfies a threshold.

In some cases, the computing system may compare the updated model and the criteria to verify a confidence metric (e.g., a confidence or certainty that the updated model maps the one or more entities, obstacles, structures, and/or objects to sensor data), a probability metric (e.g., a probability or predicted accuracy that the updated model maps the one or more entities, obstacles, structures, and/or objects to sensor data), etc. satisfies a threshold. For example, the computing system may verify the confidence metric, the probability metric, etc. satisfies the threshold to verify (e.g., confirm) that the one or more entities, obstacles, structures, and/or objects are safe for navigation by the robot.

In some cases, based on verifying that the updated model satisfies the criteria, the computing system may instruct navigation of the one or more entities, obstacles, structures, and/or objects. For example, the computing system may instruct navigation of a set of stairs based on verifying that the model is associated with a confidence metric that satisfies a threshold.

In some cases, based on verifying that the updated model satisfies the criteria, the computing system may instruct navigation of the one or more entities, obstacles, structures, and/or objects using an adjusted manner of navigation (e.g., a further adjusted manner of navigation where the mapping maneuver includes an adjustment to a manner of navigation). For example, the computing system may instruct navigation of the environment (e.g., a portion of the environment not corresponding to the one or more entities, obstacles, structures, and/or objects) according to a first gait based on determining that the model does not satisfy the criteria. The computing system may obtain an updated model based on instructing navigation of the environment according to the first gait and verify that the updated model satisfies the criteria. The computing system may instruct navigation of the one or more entities, obstacles, structures, and/or objects according to a second gait (e.g., the second gait different as compared to the first gait) based on verifying that the updated model satisfies the criteria.

In some cases, the computing system may not instruct navigation of the one or more entities, obstacles, structures, and/or objects. For example, the computing system may not instruct (e.g., may prohibit) navigation of the one or more entities, obstacles, structures, and/or objects if the computing system does not verify (e.g., is not able to verify) that the updated model satisfies the criteria (e.g., based on determining that the robot cannot safely navigate the one or more entities, obstacles, structures, and/or objects).

In the event that the computing system does not verify that the model satisfies the criteria, the computing system may adjust a manner of navigation of the robot (e.g., may adjust a gait, a swing height, etc. of the robot) and may instruct navigation of the one or more entities, obstacles, structures, and/or objects using the adjusted manner of navigation.

In the event that the computing system does not verify that the model satisfies the criteria, the computing system may instruct performance of one or more additional mapping maneuvers (e.g., according to the hierarchical plurality of mapping maneuvers). For example, the computing system may instruct performance of an additional mapping maneuver by instructing navigation of the robot to a location within the environment, adjusting a pose, orientation, position, etc. of the robot, instructing movement of an appendage of the robot, adjusting a gait of the robot, adjust a leg swing height of the robot, adjust a body height, etc., may obtain additional sensor data based on instructing performance of the additional mapping maneuver, may obtain a further updated model based on the additional sensor data, and may compare the further updated model to the criteria.

In the event that the computing system does not verify that the model satisfies the criteria, the computing system may instruct the robot to stop navigation. In some cases, in the event that the computing system does not verify that the model satisfies the criteria, the computing system may generate and provide ant an alert. For example, the computing system may generate an alert indicating that the model does not map (e.g., does not identify and/or indicate) one or more entities, obstacles, structures, and/or objects and may route the alert to a user computing device (e.g., for display via a display of the user computing device).

While reference may be made to a set of stairs, a stair model, a stair tracker, etc. herein, any object, entity, structure, and/or obstacle may be determined such that navigation of an environment is adjusted based on the determination.

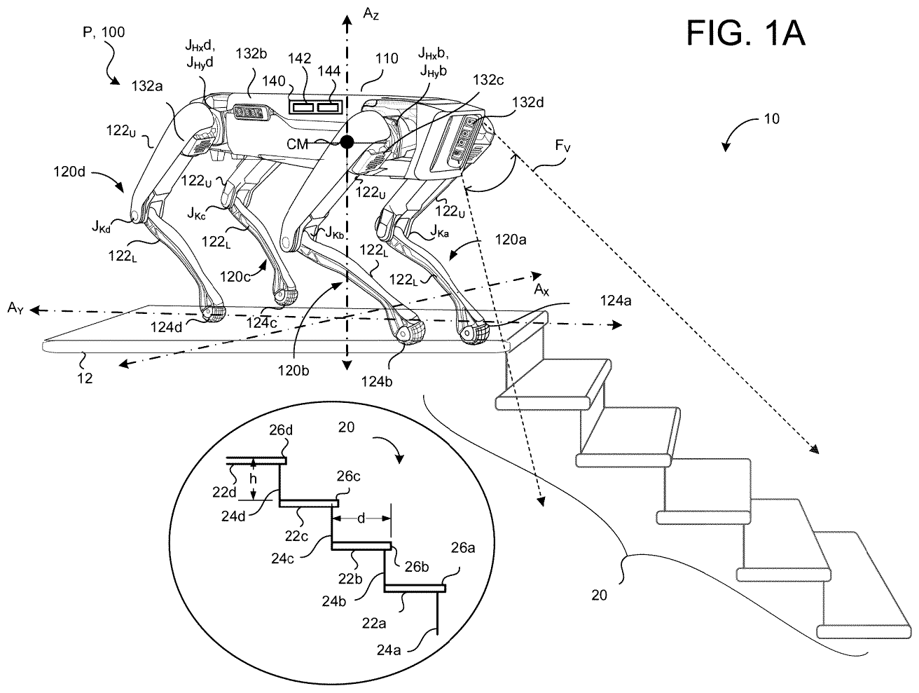

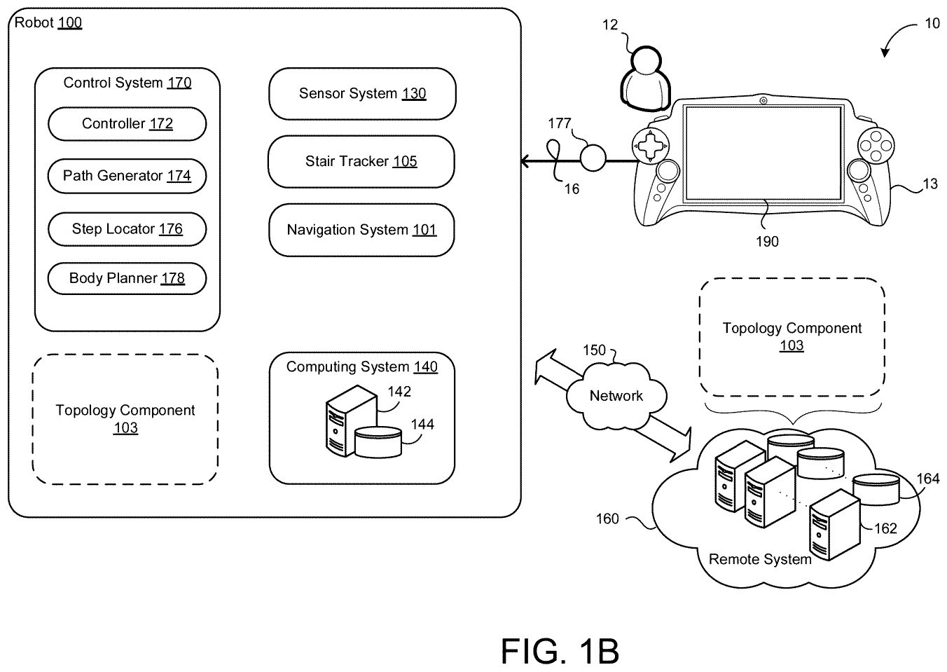

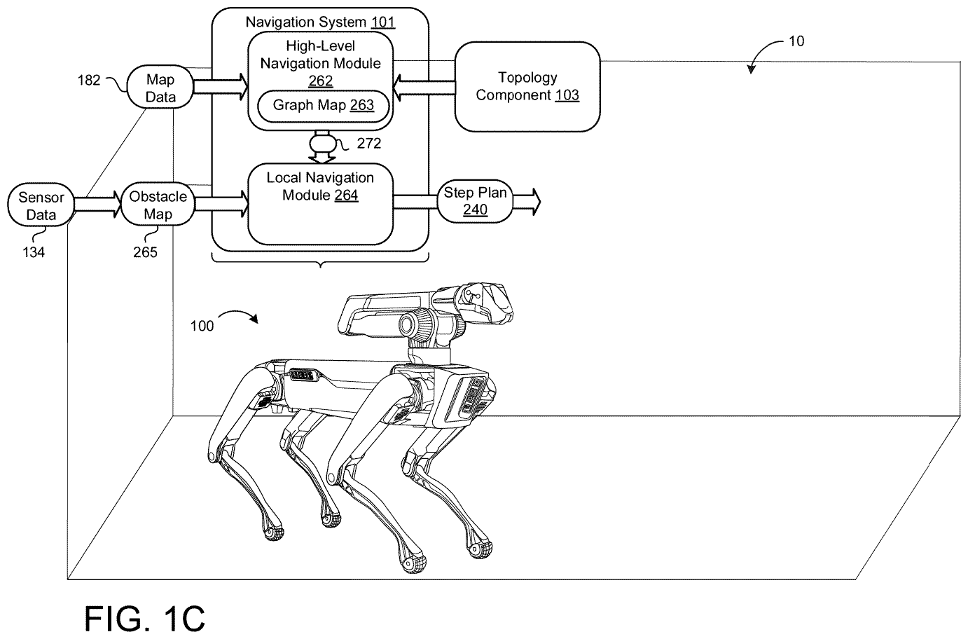

FIG. 1A is a schematic view of an example robot 100 for navigating within an environment 10 that includes a set of stairs. The environment 10 may refer to a spatial area associated with a type of terrain. As illustrated in FIG. 1A, the environment includes set of stairs 20 or stair-like terrain that may be traversed by the robot 100 (e.g., using a control system of the robot).

Stair-like terrain may include obstacles, structures, and/or objects (e.g., a sloping or elevated ground surface, a box, a pallet, etc.) that vary in height over some distance. Stair-like terrain may resemble stairs in terms of a change in elevation (e.g., an inclined pitch with a gain in elevation or a declined pitch with a loss in elevation). Further, stair-like terrain may refer to terrain with tread-like portions that allow a robot to gain traction to plant a stance limb and sequentially or simultaneously use a leading limb to ascend or to descend over an adjacent vertical obstruction (e.g., resembling a riser) within the terrain. For example, stair-like terrain my include rubble, an inclined rock scramble, damaged or deteriorating traditional stairs, etc.

One or more systems of the robot 100 may coordinate and move the robot 100 about the environment 10. As the robot 100 moves about the environment 10, the one or more systems may analyze the environment, plan motion trajectories for the robot 100 (e.g., with a path generator, a step planner, a body planner), and/or instruct the robot 100 to perform various movements (e.g., with one or more controllers). In some implementations, the robot 100 may use one or more systems of the robot 100 to attempt to successfully traverse the environment 10 while avoiding collisions and/or damage to the robot 100 or the environment 10.

The set of stairs 20 generally refers to a group of stairs (e.g., a group of “n” stairs, where n can be any number) designed to bridge a vertical distance. To bridge the vertical distance, set of stairs 20 may run a horizontal distance with a given rise in vertical height over a pitch (or pitch line).

All or a portion of the set of stairs 20 may include a tread and a riser. The tread of a stair may refer to a horizontal part of the stair that is stepped on and a rise may refer to a vertical portion of the stair between two treads. The tread of a stair may span a tread depth “d” measuring from an outer edge of a stair to a riser. The riser of a stair may span a riser height “h” measuring from an outer edge of a stair to a tread.

In some cases, a stair may include a nosing as part of the edge. As shown in FIG. 1A, the nosing may include a part of the tread that protrudes over a riser beneath the tread. For example, the nosing may be part of the tread and may protrude over the riser.

In the example of FIG. 1A, the set of stairs includes a first riser 24a, a first edge 26a, a first tread 22a, a second riser 24b, a second edge 26b, a second tread 22b, a third riser 24c, a third edge 26c, a third tread 22c, a fourth riser 24d, a fourth edge 26d, and a fourth tread 22d.

The set of stairs 20 may be preceded by or include a landing 12 (e.g., a level support surface). For example, the landing may be a level platform or support surface 12 at the top of the set of stairs 20 or at a location between stairs of the set of stairs 20. For instance, a landing 12 may occur when a direction of the set of stairs 20 changes or between a particular number of stairs of the set of stairs 20 (e.g., a set of stairs 20 that connects two floors). In the example of FIG. 1A, the landing 12 is located at the top of the set of stairs 20.

In some cases, the set of stairs 20 may be constrained between one or more walls and/or railings. In some examples, a wall may include a toe board (e.g., baseboard-like structure or runner at ends of the treads) or a stringer. In some cases, the set of stairs 20 may include a stringer that functions as a toe board (e.g., a metal stringer).

The robot 100 may include a body 110 with one or more locomotion based structures (e.g., legs) that enable the robot 100 to move about the environment 10. In the example of FIG. 1A, the robot 100 includes a body 110 with a left front leg 120a, a right front leg 120b, a left rear leg 120c, and a right rear leg 120d coupled to the body 110.

All or a portion of the left front leg 120a, the right front leg 120b, the left rear leg 120c, and the right rear leg 120d may be an articulable structure such that one or more joints permit members of the leg to move. For example, all or a portion of the left front leg 120a, the right front leg 120b, the left rear leg 120c, and the right rear leg 120d may include a hip joint J_{H} coupling an upper member 122u of the leg to the body 110, and a knee joint J_{K} coupling the upper member 122u of the leg to a lower member 122_{L} of the leg. For impact detection, the hip joint J_{H} may be further broken down into abduction-adduction rotation of the hip joint J_{H} (designated as “J_{Hx}”) for occurring in a frontal plane of the robot 100 (e.g., an X-Z plane extending in directions of the x-direction axis Aₓ and the z-direction axis A_{Z}) and a flexion-extension rotation of the hip joint J_{H} (designated as “J_{Hy}”) for occurring in a sagittal plane of the robot 100 (i.e., a Y-Z plane extending in directions of the y-direction axis A_{Y} and the z-direction axis A_{Z}). Although FIG. 1A depicts a quadruped robot with four legs, the robot 100 may include any number of locomotive based structures (e.g., the robot 100 may be a biped or humanoid robot with two legs) that provide a means to traverse the terrain within the environment 10.

In order to traverse the terrain, all or a portion of the left front leg 120a, the right front leg 120b, the left rear leg 120c, and the right rear leg 120d may have a distal end (e.g., a foot) that contacts a ground surface of the terrain (e.g., a traction surface). In other words, the distal end may be an end of the leg used by the robot 100 to pivot, plant, or generally provide traction during movement of the robot 100. For example, the distal end may correspond to a “foot” of the robot 100. In some examples, though not shown, the distal end of the leg may include an ankle joint J_{A} such that the distal end is articulable with respect to the lower member 122_{L} of the leg. In the example of FIG. 1A, the left front leg 120a includes a distal end 124a, the right front leg 120b includes a distal end 124b, the left rear leg 120c includes a distal end 124c, and the right rear leg 120d includes a distal end 124d.

The robot 100 may have a vertical gravitational axis (e.g., shown as a Z-direction axis A_{Z}) along a direction of gravity, and a center of mass (“CM”) (e.g., the center of mass may be a point where the weighted relative position of the distributed mass of the robot 100 sums to zero). The robot 100 may further have a pose P based on the CM relative to the vertical gravitational axis A_{Z} (e.g., the fixed reference frame with respect to gravity) to define a particular attitude or stance assumed by the robot 100. The attitude of the robot 100 can be defined by an orientation or an angular position of the robot 100 in space. Movement by all or a portion of the legs of the robot 100 relative to the body 110 may alter the pose P of the robot 100 (e.g., the combination of the position of the CM of the robot 100 and the attitude or orientation of the robot 100).

As the robot 100 moves about the environment 10, all or a portion of the legs of the robot 100 may undergo a gait cycle. A gait cycle may begin when a leg touches down or contacts a support surface (e.g., a ground surface beneath the robot 100) and ends when that same leg once again contacts the support surface. The touching down of a leg may also be referred to as a “footfall” defining a point or position where the distal end of a leg contacts the support surface.

The gait cycle may be divided into two phases, a swing phase and a stance phase. During the swing phase, a leg may (i) lift-off from the support surface (also sometimes referred to as toe-off and the transition between the stance phase and swing phase), (ii) perform flexion at a knee joint J_{K} of the leg, (iii) perform extension of the knee joint J_{K} of the leg, and (iv) touchdown (or footfall) back to the support surface 12. A leg in the swing phase may be referred to as a swing leg. As a swing leg moves through the swing phase, another leg may be in the stance phase. A leg swing height may refer to a height of a portion of the leg (e.g., a height of a distal end of a leg, a height of a upper portion of the leg connecting the body of the robot and the knee joint of the robot, a height of a lower portion of the leg connecting the knee joint to the distal end, etc.) during the swing phase relative to a ground surface of the robot. For example, the leg swing height may be a maximum height of a portion of the leg achieved during the swing phase.

During a stance phase, a distal end of the leg may be on the support surface. Further, the leg may (i) perform initial support surface contact which triggers a transition from the swing phase to the stance phase, (ii) perform a loading response where the leg dampens support surface contact, (iii) perform mid-stance support for when a contralateral leg (e.g., the swing leg) lifts-off and swings to a balanced position (about halfway through the swing phase), and (iv) performs terminal-stance support from when the robot's CM is over the leg until the contralateral leg touches down to the support surface. A leg in the stance phase may be referred to as a stance leg.

To enable the robot 100 to perceive the environment 10, the robot 100 may include a sensor system with one or more sensors. The one or more sensors may include vision/image sensors, inertial sensors (e.g., an inertial measurement unit (IMU)), force sensors, and/or kinematic sensors. For example, the one or more sensors may include a camera such as a stereo camera, a scanning light-detection and ranging (LIDAR) sensor, or a scanning laser-detection and ranging (LADAR) sensor.

In some cases, the robot 100 may include two stereo cameras at a front end of the body 110 of the robot 100 (e.g., a “head” of the robot 100 adjacent the to the left front leg 120a and the right front leg 120b of the robot 100) and one stereo camera at a back end of the body 110 of the robot 100 (e.g., adjacent to the left rear leg 120c and the right rear leg 120d of the robot 100). In the example of FIG. 1A, the robot 100 includes one or more first sensors 132a, one or more second sensors 132b, one or more third sensors 132c, and one or more fourth sensors 132d.

In some cases, all or a portion of the sensors may have a corresponding field of view Fᵥ, defining a sensing range or region corresponding to the sensor. All or a portion of the sensors may be pivotable and/or rotatable such that the sensor may change the field of view F_{V} about one or more axis (e.g., an x-axis, a y-axis, or a z-axis in relation to a ground plane).

In some cases, the sensor system may include one or more sensors coupled to a joint J. The one or more sensors may be coupled to a motor that operates a joint J of the robot 100 (e.g., the one or more first sensors 132a and/or the one or more second sensors 132b). The one or more sensors may generate joint dynamics in the form of joint-based sensor data. Joint dynamics collected as joint-based sensor data may include joint angles (e.g., an upper member 122u relative to a lower member 122_{L}), joint speed (e.g., joint angular velocity or joint angular acceleration), and/or joint torques experienced at a joint J (also referred to as joint forces). Further, joint-based sensor data may include raw sensor data, data that is further processed to form different types of joint dynamics, etc. For example, a sensor may measure joint position (or a position of member(s) coupled at a joint J) and systems of the robot 100 may perform further processing to identify velocity and/or acceleration from the positional data. In other examples, one or more sensors may be configured to measure (e.g., directly) velocity and/or acceleration.

When surveying a field of view F_{V} with a sensor, the sensor system may generate sensor data (e.g., image data) corresponding to the field of view F_{V}. For example, the sensor data may be image data that corresponds to a three-dimensional volumetric point cloud generated by a three-dimensional volumetric image sensor.

In some cases, when the robot 100 is maneuvering about the environment 10, the sensor system may gather pose data for the robot 100 that includes inertial measurement data (e.g., measured by an IMU). In some cases, the pose data may include kinematic data and/or orientation data about the robot 100 (e.g., kinematic data and/or orientation data about joints J or other portions of a leg of the robot 100. A perception system of the robot 100 may generate map data (e.g., one or more maps) of the environment 10.

The sensor system may gather (e.g., while the robot 100 navigates the environment) sensor data relating to the environment 10 and/or structure of the robot 100 (e.g., joint dynamics and/or odometry of the robot 100). In the example of FIG. 1A, the sensor system may obtain sensor data associated with the set of stairs 20. As the sensor system gathers sensor data, a computing system 140 of the robot 100 may store, process, and/or communicate the sensor data to various systems of the robot 100 (e.g., a control system of the robot, a navigation system of the robot, and/or a stair tracker of the robot).

To perform computing tasks (e.g., related to the sensor data), the computing system 140 of the robot 100 may include data processing hardware 142 and memory hardware 144. The data processing hardware 142 may execute instructions stored in the memory hardware 144 to perform computing tasks for the robot 100. For example, the computing system 140 may refer to one or more instances of data processing hardware 142 and/or memory hardware 144.

In some cases, the computing system 140 may be a local system located on the robot 100. For example, the computing system 140 may be centralized (e.g., in a single location/area on the robot 100 such as the body 110 of the robot 100), decentralized (e.g., located at various locations on the robot 100), or a hybrid combination of both (e.g., with a majority of the hardware being centralized and a minority of the hardware being decentralized). In some cases, the computing system 140 may be a decentralized computing system. For example, a decentralized computing system may process data at an activity location (e.g., at a motor that moves a joint of a leg 120) while a centralized computing system may be a central processing hub that communicates to systems located at various positions on the robot 100 (e.g., communicate to the motor that moves the joint of the leg).

With reference to FIG. 1B, the environment 10 includes a robot 100, a remote controller 13, and a remote system 160. All or a portion of the robot 100, the remote controller 13, and the remote system 160 may be in communication via one or more networks.

In the example of FIG. 1B, the robot 100 includes a control system 170, a sensor system 130, a stair tracker 105, a navigation system 101, a computing system 140, and a topology component 103. In some cases, the navigation system 101 may be a perception system (e.g., the primary perception system). In some cases, the robot 100 may include a separate perception system.

The sensor system 130 of the robot 100 gathers sensor data, the computing system 140 of the robot 100 stores, processes, and/or communicates the sensor data to various systems of the robot 100 (e.g., a control system 170, a navigation system 101, a topology component 103, a stair tracker 105, and/or a remote controller 13). For example, the sensor system 130 may include the one or more first sensors 132a, the one or more second sensors 132b, the one or more third sensors 132c, the one or more fourth sensors 132d, etc.

As discussed herein, to perform computing tasks, the computing system 140 of the robot 100 includes data processing hardware 142 and memory hardware 144.

In some cases, the computing system 140 may employ and/or interact with computing resources that are located remotely from the robot 100. For instance, the computing system 140 may communicate via a network 150 with a remote system 160 (e.g., a remote computer/server or a cloud-based environment). The remote system 160 may include remote computing resources such as remote data processing hardware 162 and remote memory hardware 164. The remote system 160 may store sensor data or other processed data (e.g., data processing locally by the computing system 140) such that the data is accessible to the computing system 140. In some implementations, the computing system 140 may utilize the remote data processing hardware 162 and/or the remote memory hardware 164 as extensions of the data processing hardware 142 and/or the memory hardware 144 such that resources of the computing system 140 may reside on resources of the remote system 160.

A perception system of the robot may receive the sensor data from the sensor system 130 and may process the sensor data to generate map data (e.g., one or more maps). For example, the map data (e.g., one or more perception maps) may include a ground height map, a no step map, and/or a body obstacle map. In some cases, the map data may include predefined map data and/or live map data.

The ground height map may be based on voxels from a voxel map. In some cases, the ground height map may indicate for and/or include within each X-Y location within a grid of the map (e.g., designated as a cell of the ground height map) a particular height. For example, the ground height map may convey that, at a particular X-Y location in an environment, the robot 100 should step at a certain height.

The no step map may define regions where the robot 100 should not (e.g., is not allowed to) step (e.g., based on one or more obstacles, structures, objects, and/or entities). For example, the no step map may indicate where to step and where not to step. In some cases, the no step map may be partitioned into a grid of cells where all or a portion of the cells may represent a particular area in the environment 10 of the robot 100. For example, all or a portion of the cells may correspond to a three centimeter square within an X-Y plane within the environment 10.

The no step map may be associated with (e.g., may include) a map (e.g., a Boolean value map) indicating “no step” regions and “step” regions. A no step region may be a region of one or more cells where an obstacle is perceived to exist while a step region may be a region of one or more cells where an obstacle is not perceived to exist. In some cases, the no step map may include a signed-distance field indicating, for all or a portion of the cells, a distance to a boundary of an obstacle (e.g., a distance to a boundary of the no step region) and a vector “v” (e.g., defining nearest direction to the boundary of the no step region) to the boundary of an obstacle.

The body obstacle map (e.g., a map of obstacles for the body of the robot 100) may define areas where the body of the robot 100 may overlap with an obstacle, entity, structure, and/or object. For example, the body obstacle map may map obstacles, entities, structures, and/or objects that the body of the robot 100 may collide with or contact. Systems of the robot 100 (e.g., the control system 170) may use the body obstacle map to identify boundaries adjacent, or nearest to, the robot 100 and/or identify directions to move the robot 100 in order to avoid an obstacle. In some cases, the body obstacle map may include a grid of cells (e.g., a grid of cells in the X-Y plane), all or a portion of the cells including and/or indicating a distance from an obstacle and a vector pointing to the closest cell that is mapped as a portion of an obstacle (e.g., a boundary of the obstacle).

The perception system may communicate the map data to the control system 170, the stair tracker 105, the navigation system 101, and/or the topology component 103. The control system 170 may use the map data to instruct the robot 100 to perform controlled actions (e.g., moving within the environment 10). In some cases, the navigation system 101 may be separate from, yet in communication with, the control system 170, such that the control system 170 controls the robot 100 while the navigation system 101 interprets the sensor data gathered by the sensor system 130. In some cases, the control system 170 and the navigation system 101 may execute in parallel to ensure accurate, fluid movement of the robot 100 in an environment 10.

As discussed herein, the stair tracker 105 of the robot 100 may receive the sensor data from the sensor system 130 and may detect and/or track features of a set of stairs based on the received sensor data. In some cases, the stair tracker 105 may be activated based on the robot 100 entering a stairs mode. The stair tracker 105 may detect a set of stairs based on the sensor data from the sensor system 130. In some cases, the stair tracker 105 may detect features of the set of stairs based on the sensor data. For example, the stair tracker 105 may detect one or more walls, risers, edges, corners, treads, etc. of the set of stairs.

Based on detecting and/or tracking the features of the set of stairs, the stair tracker 105 may build a stair model of the set of stairs. For example, the stair model may indicate the features of the set of stairs. The stair tracker 105 may provide the stair model to the control system 170, the topology component 103, and/or the navigation system 101. In some cases, the stair tracker 105 may provid the stair model to a perception system of the robot.

In some cases, the topology component 103 may be executed on the data processing hardware 142 (e.g., local to the robot 100). In some cases, the topology component 103 may be executed on the remote data processing hardware 162 (e.g., remote from the robot 100). In some cases, the topology component 103 may be part of the navigation system 101. In some cases, the environment 10 may not include the topology component 103.

The topology component 103 may generate map data (e.g., a graph map, a topological map, etc.) and provide the map data to the control system 170. In some cases, the topology component 103 may obtain map data (e.g., from a perception system), may adjust the map data, and may provide the adjusted map data to the control system 170.

In some cases, the topology component 103 may generate, identify, adjust, etc. a series of route waypoints and/or a series of route edges. For example, the topology component 103 may generate a series of route waypoints and a series of route edges based on the sensor data. In some cases, the topology component 103 may perform loop closure to identify one or more route waypoints and/or one or more route edges. In some cases, the topology component 103 may generate a series of route waypoints and a series of route edges based on the sensor data. In some cases, the topology component 103 may obtain a series of route waypoints and/or a series of route edges and adjust the series of route waypoints and/or the series of route edges based on an embedding (e.g., linking one or more route waypoints and/or route edges to a location within the environment. The topology component 103 may provide the map data, the series of route waypoints, and/or the series of route edges to the control system 170, the stair tracker 105, the topology component 103, and/or the navigation system 101.

In some cases, the navigation system 101 may obtain the stair model from the stair tracker 105 and/or may obtain the map data (e.g., the adjusted map data) from the topology component 103.

A system of the robot 100 (e.g., a step planner) may generate a step plan based on the stair model and/or the map data and may provide the step plan to the control system 170. In some cases, the system may generate the step plan based on predefined map data and/or live map data. The step plan may indicate and/or identify a location of one or more step locations for one or more distal ends of one or more legs of the robots.

The control system 170 may communicate with the sensor system 130 and any other system of the robot 100 (e.g., the navigation system 101 and/or the stair tracker 105). The control system 170 may perform operations and other functions using the data processing hardware 142. In the example of FIG. 1B, the control system 170 includes a controller 172, a path generator 174, a step locator 176, and a body planner 178.

The controller 172 may control movement of the robot 100 to traverse the environment 10 based on input or feedback from the systems of the robot 100 (e.g., the control system 170, the navigation system 101, and/or the stair tracker 105). This may include movement between poses and/or behaviors of the robot 100. For example, the controller 172 may control different footstep patterns, leg patterns, body movement patterns, and/or vision system sensing patterns.

In some cases, the control system 170 may include a plurality of controllers. All or a portion of the plurality of controllers may operate the robot 100 at a fixed cadence (e.g., a fixed timing for a step or swing phase of a leg). For example, an individual controller may instruct the robot 100 to move a leg of the robot 100 (e.g., take a step) at a particular frequency (e.g., step every 250 milliseconds, 350 milliseconds, etc.). By using a plurality of controllers that can each operate the robot 100 at a fixed cadence, the robot 100 can experience variable timing by switching between different controllers. In some cases, the robot 100 may continuously switch between/select different fixed cadence controllers (e.g., re-select a controller every three milliseconds) as the robot 100 traverses the environment 10.

In some cases, the control system 170 may include one or more specialty controllers that are dedicated to a particular control purpose. For example, the control system 170 may include one or more stair controllers dedicated to planning and coordinating the robot's movement to traverse a set of stairs. The stair controller may ensure the footpath for a swing leg ₘₐᵢₙₜₐᵢₙₛ a swing height to clear a riser and/or edge of a stair of the set of stairs. Other specialty controllers may include the path generator 174, the step locator 176, and/or the body planner 178.

The path generator 174 may determine horizontal motion for the robot 100. As used herein, the term “horizontal motion” may refer to translation (e.g., movement in the X-Y plane) and/or yaw (e.g., rotation about the Z-direction axis A_{z}) of the robot 100. The path generator 174 may determine obstacles within the environment 10 about the robot 100 based on the sensor data. The path generator 174 may determine the planned path of the body of the robot 100 for a particular time period (e.g., for the next 1-1.5 seconds). In some cases, the path generator 174 may determine a new planned path for the body (e.g., every few milliseconds) and each path may be planned for a period of 1-1.5 or so seconds into the future.

The path generator 174 may communicate data regarding a planned path, as well as identified obstacles, to the step locator 176. The step locator 176 may use the communicated data to identify placement locations for distal ends of legs of the robot 100 (e.g., locations to place the distal ends the robot 100). The step locator 176 may generate the placement locations (e.g., locations where the robot 100 should step) using the map data from the perception system (e.g., the one or more maps).

The body planner 178 may receive inputs from the perception system (e.g., the one or more maps). The body planner 178 may adjust dynamics of the body of the robot 100 (e.g., rotation, such as pitch or yaw and/or height of CM) for movement by the robot 100 about the environment 10.

The perception system may enable the robot 100 to move within the environment (e.g., around various obstacles, entities, structures, and/or objects). As the sensor system 130 collects sensor data associated with the environment 10, the perception system may use the sensor data to form map data (e.g., one or more maps) of the environment 10. In some cases, the perception system may modify a map based on the sensor data (e.g., by projecting sensor data on a preexisting map, removing data from a map).

An operator 12 (also referred to herein as a user or a client) may interact with the robot 100 via the remote controller 13 that communicates with the robot 100 to perform actions. For example, the operator 12 transmits commands 177 to the robot 100 (executed via the control system 170) via a wireless communication network 16. Additionally, the robot 100 may communicate with the remote controller 13 to display an image on a user interface 190 of the remote controller 13. For example, the user interface 190 may display the image that corresponds to three-dimensional field of view F_{V} of the one or more sensors of the robot 100. The image displayed on the user interface 190 of the remote controller 13 may be a two-dimensional image that corresponds to the three-dimensional point cloud of sensor data (e.g., field of view F_{V}) for the area within the environment 10 of the robot 100. For example, the image displayed on the user interface 190 may be a two-dimensional image representation that corresponds to the three-dimensional field of view F_{V} of the one or more sensors.

Referring now to FIG. 1C, the robot 100 (e.g., the data processing hardware 142 as discussed herein with reference to FIGS. 1A and 1B) may execute a navigation system 101 for enabling the robot 100 to navigate the environment 10. A sensor system of the robot 100 may include one or more sensors (e.g., image sensors, lidar sensors, ladar sensors, etc.) that can each capture sensor data 134 of the environment 10. The sensor system may move a field of view F_{V} of the one or more sensors by adjusting an angle of view or by panning and/or tilting (either independently or via the robot 100) the one or more sensors to move the field of view F_{V} in any direction. In some cases, the sensor system may include a plurality of sensors (e.g., multiple cameras) such that the sensor system captures a generally 360-degree field of view around the robot 100.

In the example of FIG. 1C, the navigation system 101 includes a high-level navigation module 262 that receives map data 182 (e.g., high-level navigation data representative of locations of static obstacles in an area the robot 100 is to navigate). In some cases, the map data 182 includes a graph map 263. In other cases, the high-level navigation module 262 may generate the graph map 263. The graph map 263 may include a topological map of a given area the robot 100 is to traverse. The high-level navigation module 262 can obtain (e.g., from a remote system, a remote controller, a topology component, etc.) and/or generate a series of route waypoints on the graph map 263 for a navigation route 272 that may plot a path around large and/or static obstacles from a start location (e.g., the current location of the robot 100) to a destination. Route edges may connect corresponding pairs of adjacent route waypoints. In some examples, the route edges record geometric transforms between route waypoints based on odometry data (e.g., odometry data from motion sensors or image sensors to determine a change in the robot's position over time). The route waypoints and the route edges may be representative of the navigation route 272 for the robot 100 to follow from a start location to a destination location.

As discussed in more detail herein, in some examples, the high-level navigation module 262 may receive the map data 182, the graph map 263, and/or a graph map from a topology component 103. The topology component 103, in some examples, is part of the navigation system 101 and may be executed locally at or remote from the robot 100.

In some implementations, the high-level navigation module 262 produces the navigation route 272 over a greater than 10-meter scale (e.g., the navigation route 272 may include distances greater than 10 meters from the robot 100). The scale for the high-level navigation module 262 can be set based on the robot 100 design and/or the desired application, and may be larger than the range of the one or more sensors of the sensor system.

In the example of FIG. 1C, the navigation system 101 includes a local navigation module 264 that can receive the navigation route 272 and an obstacle map 265 based on the sensor data 134 (e.g., image data) from the sensor system. In some cases, the local navigation module 264, using the sensor data 134, can generate the obstacle map 265. The obstacle map 265 may be a robot-centered map that maps obstacles (static and/or dynamic obstacles) in the vicinity (e.g., satisfies a threshold) of the robot 100 based on the sensor data 134. For example, while the graph map 263 may include data relating to the locations of walls of a hallway, the obstacle map 265 (populated by the sensor data 134 as the robot 100 traverses the environment 10) may include information regarding a stack of boxes placed in the hallway that were not present during the original recording. The size of the obstacle map 265 may be dependent upon both the operational range of the one or more sensors and the available computational resources.

The local navigation module 264 can generate a step plan 240 (e.g., using an A* search algorithm) that plots all or a portion of the individual steps (or other movements) of the robot 100 to navigate from the current location of the robot 100 to the next route waypoint along the navigation route 272. For example, the local navigation module 264 may generate the step plan 240 using the obstacle map 265. Using the step plan 240, the robot 100 can maneuver through the environment 10. The local navigation module 264 may obtain a path for the robot 100 to the next route waypoint using an obstacle grid map based on the sensor data 134. In some examples, the local navigation module 264 operates on a range correlated with the operational range of the one or more sensors (e.g., four meters) that may be less than the scale of high-level navigation module 262.

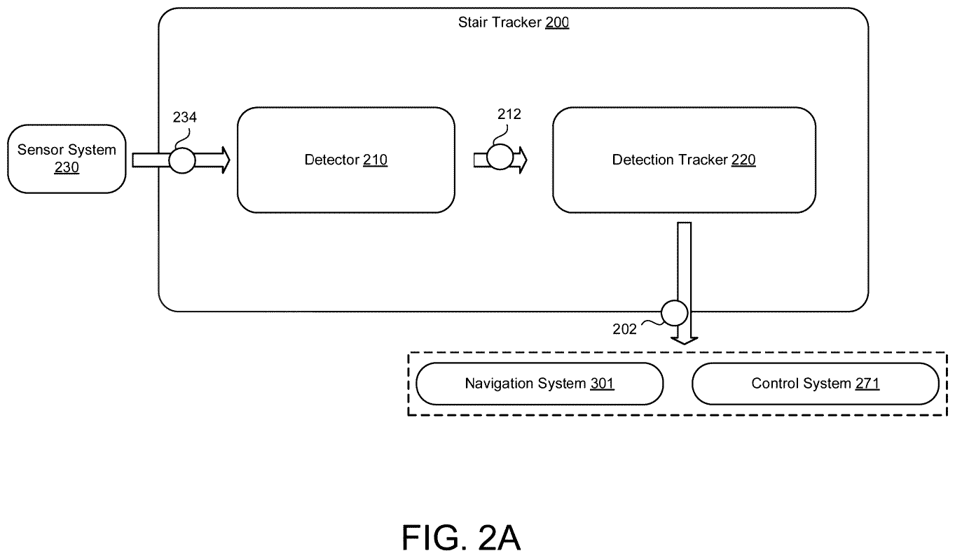

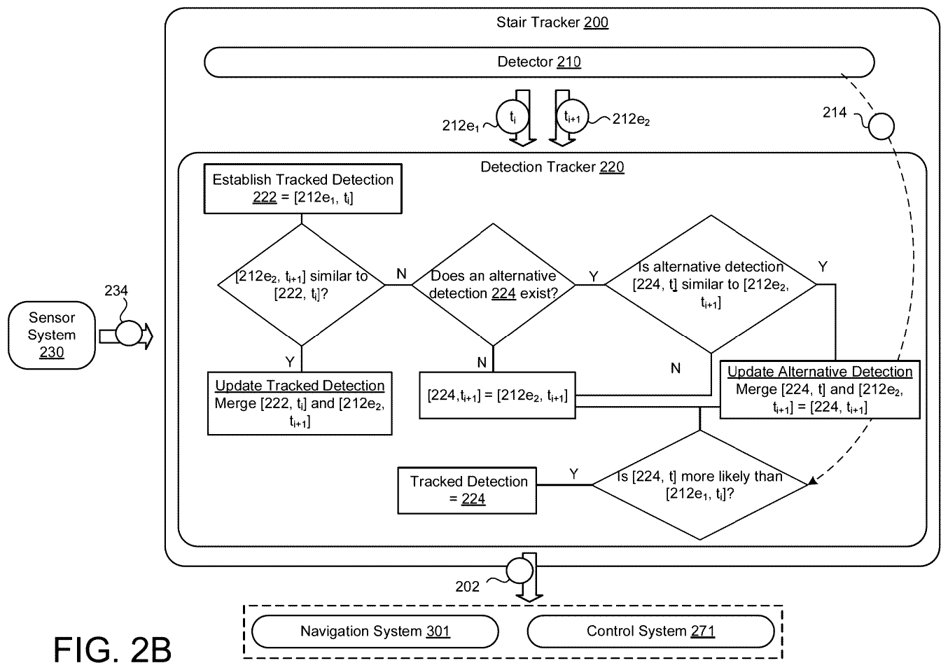

As discussed herein, the robot a tracker (e.g., a stair tracker) for detecting and tracking features of objects, entities, obstacles, and/or structures within the environment and generating a corresponding model. The tracker may enable the robot to detect and track objects, entities, obstacles, and/or structures that may be associated with poorer quality sensor data as compared to other portions of the environment. FIG. 2A and FIG. 2B may each be a schematic view of an example stair tracker of a robot (e.g., which may include and/or may be similar to the robot 100 discussed herein with reference to FIG. 1A, FIG. 1B, and FIG. 1C).

Referring to FIG. 2A, the stair tracker 200 (e.g., which may include and/or may be similar to the stair tracker 105 discussed herein with reference to FIG. 1B) may obtain sensor data 234 (e.g., which may include and/or may be similar to the sensor data 134 discussed herein with reference to FIG. 1C) from the sensor system 230 (which may include and/or may be similar to the sensor system 130 discussed herein with reference to FIG. 1B) and output a stair model 202 to the navigation system 201 (which may include and/or may be similar to the navigation system 101 discussed herein with reference to FIGS. 1B and 1C) and/or the control system 271 (which may include and/or may be similar to the control system 170 discussed herein with reference to FIGS. 1B and 1C). As discussed herein, the stair model 202 may indicate one or more features of a set of stairs. For example, the stair model 202 may indicate the set of stairs and a surface height. In some cases, the stair model 202 may indicate a configuration, location, orientation, etc. of the set of stairs relative to the robot. For example, a stair may be a line segment with a direction, a location, and an extent in either direction. In some cases, the stair tracker 200 may assume the stairs are horizontally constrained and include a minimum/maximum rise and a minimum/maximum run. Alternatively, the slope may be constrained to a minimum/maximum value.

As shown in FIG. 2A, the stair tracker 200 includes a detector 210 and a detection tracker 220 (e.g., for generation of the stair model 202). The detector 210 of the stair tracker 200 may receive the sensor data 234 from the sensor system 230 and may generate one or more detected features 212. The one or more detected features 212 may correspond to different features (e.g., structural features) of the set of stairs (e.g., edges, treads, risers, walls, corners, etc.).

Referring to FIG. 2B, as the robot approaches a set of stairs, the detector 210 may determine the one or more detected features. In the example of FIG. 2B, the one or more detected features may include a first detected edge 212e₁ and a second detected edge 212e₂.

The detector 210 may detect the first detected edge 212e₁ at a particular time tᵢ. Once the detector 210 determines the first detected edge 212e₁ at the particular time tᵢ, the detection tracker 220 may monitor whether the first detected edge 212e₁ changes (e.g., remains the best representation of the feature) during future time steps. For example, the stair tracker 200 may receive sensor data 234 (e.g., at a particular frequency) as the sensor system 230 captures the sensor data 234. The detector 210 may determine the first detected edge 212e₁ at a first time step t₁ based on sensor data 234 from the first time step t₁ and aggregate sensor data from prior time steps tᵢ₋₁. The detector 210 may communicate the first detected edge 212e₁ (e.g., an identifier of the first detected edge 212e₁) to the detection tracker 220 and the detection tracker 220 may establish the first detected edge 212e₁ as a tracked detection 222 (also referred to as a primary detection) or initial detection when no primary detection exists at the detection tracker 220. For example, when the detection tracker 220 is not tracking the particular feature corresponding to the first detected edge 212e₁ received from the detector 210, the detection tracker 220 may initialize a tracking process for this feature using the first detected edge 212e₁ at the first time step t₁.

In the example of FIG. 2B, the detection tracker 220 identifies the first detected edge 212e₁ for a set of stairs at the first time step t₁ as the tracked detection 222. At a second time step t₂ subsequent to the first time step t₁, the stair tracker 200 receives sensor data 234 generated at the second time step t₂ and/or during a time period between the first time step t₁ and the second time step t₂ as the most recent sensor data 234. Using the most recent sensor data 234, the detector 210 generates a second detected edge 212e₂ for the set of stairs at a later time tᵢ₋₁.

To perform the tracking process, when the detection tracker 220 receives the second detected edge 212e₂, the detection tracker 220 may determine whether the second detected edge 212e₂ received at the second time step t₂ is similar to the first detected edge 212e₁ received at the first time step t₁ (e.g., the tracked detection 222). When the detection tracker 220 determines the first detected edge 212e₁ and the second detected edge 212e₂ are similar (e.g., the first detected edge 212e₁ and the second detected edge 212e₂ satisfy a threshold), the detection tracker 220 may merge the first detected edge 212e₁ and the second detected edge 212e₂ together to update the tracked detection 222. The detection tracker 220 may merge the first detected edge 212e₁ and the second detected edge 212e₂ together by averaging the first detected edge 212e₁ and the second detected edge 212e₂ (e.g., a weighted average weighted by a confidence error in the first detected edge 212e₁ and/or the second detected edge 212e₂).

When the detection tracker 220 determines the first detected edge 212e₁ and the second detected edge 212e₂ are not similar (e.g., the first detected edge 212e₁ and the second detected edge 212e₂ do not satisfy a threshold), the detection tracker 220 may determine whether an alternative tracked feature 224 is identified for the feature corresponding to the second detected edge 212e₂. For example, the detection tracker may determine whether the detection tracker 220 previously identified the feature as an alternative tracked feature 224). If the detection tracker 220 determines that an alternative tracked feature 224 is not identified for the feature, the detection tracker 220 may establish the second detected edge 212e₂ at the second time step t₂ to be the alternative tracked feature 224. If the detection tracker 220 determines that an alternative tracked feature 224 is identified for the feature, the detection tracker 220 may determine whether the second detected edge 212e₂ at the second time step t₂ is similar to the alternative tracked feature 224 (e.g., whether the second detected edge 212e₂ and the alternative tracked feature 224 satisfy a threshold). If the detection tracker 220 determines that the second detected edge 212e₂ is similar to the alternative tracked feature 224, the detection tracker 220 may merge the second detected edge 212e₂ and the alternative tracked feature 224 (e.g., using averaging or weighted averaging). If the detection tracker 220 determines that the second detected edge 212e₂ is not similar to the alternative tracked feature 224, the detection tracker 220 may generate an additional alternative tracked feature 224 based on the second detected edge 212e₂. In some examples, the detection tracker 220 may track and/or store multiple alternative tracked features.

The stair tracker 200 may vet each detection to prevent the stair tracker 200 from detrimentally relying on a detection. For example, as the robot may obtain (e.g., continuously) sensor data 234 associated with the environment (e.g., at a frequency of 15 Hz), a reliance on a single detection from a snapshot of sensor data 234 may cause inaccuracy as to the actual location of the features of the stairs of the set of stairs. For example, a robot may move or change its pose P between a first time and a second time and generate sensor data 234 for areas of the set of stairs that were previously occluded, partially occluded, or poorly captured in general. If the system only performed a single feature detection at the first time, the sensor data 234 may be incomplete and the feature detection may be incomplete. Instead, by updating and tracking each feature detection based on obtained sensor data 234 available to the stair tracker 200 over a period of time, the stair tracker 200 may generate a bimodal probability distribution for a detected stair feature (e.g., a primary detection and an alternative detection). With a bimodal probability distribution for a feature of a set of stairs, the stair tracker 200 may generate an accurate representation for the feature of the set of stairs to include in the stair model 202. Furthermore, the detection and tracking process may tolerate a detection at any particular instance in time that corresponds to arbitrary poor sensor data 234 because the detection may be tracked and averaged over time with other detections (e.g., presumably detections based on better data or based on a greater aggregate of data over multiple detections). Therefore, although a single detection may appear noisy at any moment in time, the merging and alternative swapping operations of the detection tracker 220 develop an accurate representation of stair features over time.

The detected stair features may then be incorporated into the stair model 202 that the stair tracker 200 generates and communicates to various systems of the robot (e.g., systems that control the robot to traverse the set of stairs). In some cases, the stair tracker 200 may incorporate a detected stair feature into the stair model 202 once the detected stair feature has been detected by the detector 210 and tracked by the detection tracker 220 for some number of iterations (e.g., a particular time period). For example, the stair tracker may incorporate the detected stair feature into the stair model based on determining the detection tracker 220 has tracked the feature for three to five detection/tracking cycles.

In some cases, the stair tracker 200 may include a first stair tracker for ascent of a set of stairs by a robot and a second stair tracker for descent of a set of stairs by the robot to account for the different quality of sensor data available when ascending a set of stairs as compared to descending the set of stairs. For example, a sensor viewing down a set of stairs may produce a different quality of sensor data than a sensor peering up a set of stairs. Further, a sensor peering up a set of stairs may have a vantage point occluding treads of the set of stairs and at least a portion of the risers of the set of set of stirs, while a sensor peering down the set of stairs may have a vantage point occluding the risers of the set of stairs and at least a portion of the treads of the set of stairs. Due to these differences, the stair tracker 200 may have separate functionality dedicated to stair ascent (e.g., a stair ascent tracker) and stair descent (e.g., a stair descent tracker). For example, each type of stair tracker may be part of the stair tracker 200, but may be implemented as separate software modules. In some configurations, each type of stair tracker, though implemented via separate modules, may coordinate with each other. For instance, the stair ascent tracker may pass information to the stair descent tracker (or vice versa) when the robot changes directions during stair navigation (e.g., on the set of stairs).

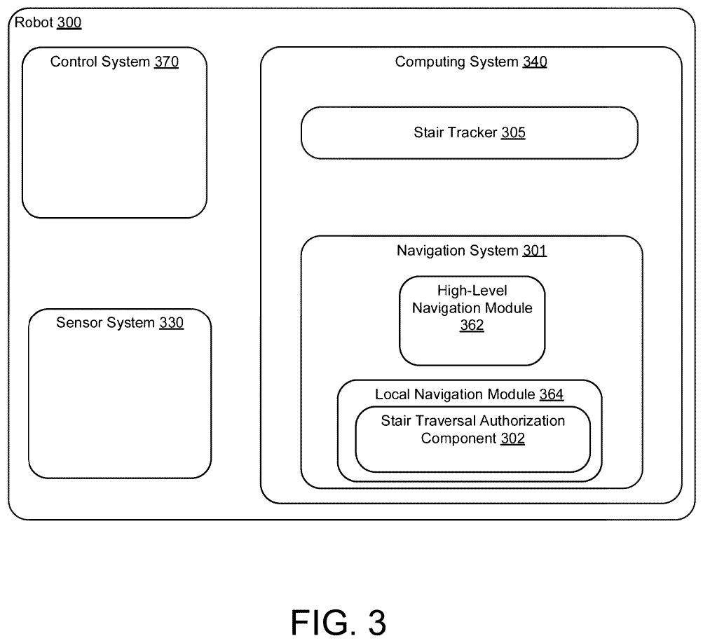

Referring now to FIG. 3, a robot 300 (which may include and/or may be similar to the robot 100 discussed herein with reference to FIG. 1A, FIG. 1B, and FIG. 1C) includes a control system 370 (which may include and/or may be similar to the control system 170 discussed herein with reference to FIG. 1B), a computing system 340 (which may include and/or may be similar to the computing system 140 discussed herein with reference to FIG. 1A and FIG. 1B), and a sensor system 330 (which may include and/or may be similar to the sensor system 130 discussed herein with reference to FIG. 1B). The computing system 340 includes a stair tracker 305 (which may include and/or may be similar to the stair tracker 105 discussed herein with reference to FIG. 1B), and a navigation system 301 (which may include and/or may be similar to the navigation system 101 discussed herein with reference to FIG. 1B and FIG. 1C). Though not shown in FIG. 3, the robot 300 may include a topology component as discussed herein.

The sensor system 330 can gather sensor data. The sensor system 330 may include a plurality of sensors (e.g., image sensors) of the robot 300 and the sensor system 330 may gather the sensor data via the plurality of sensors. The sensor system 330 may provide the sensor data to other systems of the robot 300 (e.g., the control system 370, the stair tracker 305, the navigation system 301, etc.).

In one example, the sensor system 330 may include a plurality of sensors (e.g., five sensors) distributed on the robot 300. For example, the sensor system 330 may include a plurality of sensors distributed across the body, one or more legs, arm, etc. of the robot 300. The plurality of sensors may include at least two different types of sensors. For example, the plurality of sensors may include lidar sensors, image sensors, ladar sensors, audio sensors, etc. and the sensor data may include lidar sensor data, image (e.g., camera) sensor data, radar sensor data, ladar sensor data, audio data, etc.

In some cases, the sensor data may include three-dimensional point cloud data. The sensor system 330 (or a separate system) may use the three-dimensional point cloud data to detect and track features within a three-dimensional coordinate system. For example, the sensor system 330 may use the three-dimensional point cloud data to detect and track movers within the environment.

In some cases, the sensor data may include panoramic image data. For example, the sensor data may include a 360 degree representation of the environment. In some cases, the sensor system 330 may automatically and/or continuously obtain (e.g., collect) sensor data. For example, the sensor system 330 may automatically and/or continuously obtain sensor data as the robot 300 navigates within the environment.

The computing system 340 may include data processing hardware (e.g., a data processor, a hardware processor, etc.) and memory hardware. The memory hardware may store instructions and the data processing hardware may execute the instructions which may cause the data processing hardware to perform one or more operations.

The control system 370 may include a controller, a path generator, a step locator, and/or a body planner (e.g., as discussed herein with reference to FIG. 1B). As discussed herein, the control system 370 may control the robot 300 (e.g., may instruct traversal of the robot 300 through an environment).

The stair tracker 305 may include a detector and/or a detection tracker (e.g., as discussed herein with reference to FIG. 2A and FIG. 2B).

The navigation system 301 may include one or more high-level navigation components, one or more local navigation components, and one or more stair traversal authorization components. In the example of FIG. 3, the navigation system 301 includes a high-level navigation module 362 (which may include and/or may be similar to the high-level navigation module 262 discussed herein with reference to FIG. 1C) and a local navigation module 364 (which may include and/or may be similar to the local navigation module 264 discussed herein with reference to FIG. 1C). The local navigation module 364 includes the stair traversal authorization component 302. In some cases, the local navigation module 364 may not include the stair traversal authorization component 302 and/or the stair traversal authorization component 302 may be located separately from the local navigation module 364.

The stair traversal authorization component 302 may monitor the detection of a set of stairs within the environment of the robot (e.g., based on map data indicating that the environment includes the set of stairs). Based on monitoring the detection of the set of stairs, the stair traversal authorization component 302 may instruct performance of (e.g., may adjust, may modify, etc.) one or more other systems of the robot 300 (e.g., the control system 370).

To traverse a set of stairs within an environment of the robot 300, the robot 300 may obtain sensor data via the sensor system 330. Using the sensor data, a system of the robot 300 (e.g., a perception system, a mapping system, etc.) may generate map data and/or the stair tracker 305 may generate a model associated with the environment. For example, a perception system may generate a ground height map, a no step map, and/or a body obstacle map based on the sensor data and the stair tracker 305 may generate a stair model.

In some cases, the stair tracker 305 may provide the stair model to a system of the robot 300 (e.g., a step planner) and the system may use the stair model and the one or more maps generated by the perception system to generate a step plan. The system may provide the generated step plan to the control system 370 to instruct traversal of the environment by the robot 300.

In some cases, the stair tracker 305 may provide the stair model to the control system 370. For example, the stair tracker 305 may provide the stair model to the control system 370 without separately providing the stair model to another system.

The map data may include an indication that the environment includes a set of stairs and an identifier of a location of the set of stairs. For example, a perception system may identify a set of stairs based on the sensor data and may include an identifier of the set of stairs within the map data. In another example, the perception system may obtain the stair model from the stair tracker 305 and may generate the map data based on the stair model (e.g., such that the map includes an identifier of the set of stairs based on the stair model). In some cases, the map data may include the stair model and/or the map data may be merged with the stair model.

In some cases, a perception system may generate map data during an initial mapping process (e.g., the map data may be predefined map data). For example, a user computing device may instruct the robot 300 to traverse and map the environment and, in response, the perception system may generate one or more maps associated with the environment. In some cases, the map data may indicate and/or include a navigation route of the robot 300 (e.g., a series of route waypoints and/or route edges associated with the robot 300). The perception system may store the map data and/or provide the map data to other systems of the robot 300.

The stair traversal authorization component 302 may monitor the generation and provision of the step plan and may authorize navigation (e.g., may instruct navigation) according to the step plan. In some cases, the stair traversal authorization component 302 may monitor the generation and provision of the step plan based on determining that the environment includes a set of stairs.

In some cases, the stair traversal authorization component 302 may obtain the map data associated with an environment of the robot 300. For example, the stair traversal authorization component 302 may determine a location of the robot 300 and may identify map data associated with the location of the robot 300.

Based on the location of the robot 300 and the map data, the stair traversal authorization component 302 may determine that the environment of the robot 300 includes a set of stairs (e.g., that a navigation route of the robot 300 through the environment includes traversal of the set of stairs). For example, the stair traversal authorization component 302 may determine a location of the robot 300, obtain map data associated with the location of the robot 300, and may determine that the map data includes an identifier of a set of stairs.

In some cases, to determine that the map data includes an identifier of the set of stairs, the stair traversal authorization component 302 may obtain mission data associated with the robot 300 (e.g., a navigation route of the robot 300). For example, the stair traversal authorization component 302 may identify and obtain the mission data from the map data. Based on the mission data, the stair traversal authorization component 302 may determine that the navigation route of the robot 300 includes a set of stairs. For example, the stair traversal authorization component 302 may determine that the navigation route of the robot 300 includes traversal of a set of stairs.

Based on (e.g., in response to) determining that the environment includes the set of stairs (e.g., that the navigation route of the robot 300 includes traversal of the set of stairs), the stair traversal authorization component 302 may obtain (e.g., access) a stair model (e.g., provided by the stair tracker 305). For example, the stair traversal authorization component 302 may access the stair model as stored and/or provided by the navigation system 301. In another example, the stair traversal authorization component 302 may request the stair model from the stair tracker 305 and may obtain the stair model from the stair tracker 305 in response to the request.

The stair tracker 305 may obtain sensor data via the sensor system 330 and may generate second map data (e.g., live map data including a stair model) using the sensor data. For example, the stair tracker 305 may construct a stair model using the sensor data and the stair model may map one or more features of the set of stairs to one or more portions of the sensor data (e.g., indicating a size, a dimension, etc. of the set of stairs). The stair tracker 305 may generate the stair model as the robot traverses the environment. In some cases, the second map data (e.g., the stair model) and the map data may be generated during different time periods (e.g., the map data may be generated during an initial mapping and the second map data may be generated during a current mapping).

The stair traversal authorization component 302 may review the stair model (e.g., the stair model based on live sensor data) to determine if the stair model satisfies particular criteria (e.g., a particular threshold).

In some cases, the particular criteria may indicate a threshold clarity metric, a threshold confidence metric, a threshold feature metric, a threshold quality metric, a threshold precision metric, a threshold accuracy metric, etc. For example, the stair traversal authorization component 302 may review the stair model to determine if the stair model has a predicted accuracy that satisfies a threshold accuracy metric. In another example, the stair traversal authorization component 302 may review the stair model to determine if a clarity of the stair model satisfies a threshold clarity metric. In another example, the stair traversal authorization component 302 may review the stair model to determine if the stair model indicates a particular feature of the set of stairs (e.g., an initial riser of the set of stairs, an initial tread of the set of stairs, etc.) based on a threshold feature metric. In another example, the stair traversal authorization component 302 may review the stair model to determine if a probability that the stair model indicates (e.g., is correlated with, accurately represents, represents, etc.) the set of stairs satisfies a threshold probability metric.

In some cases, the particular criteria may be based on the map data and/or the second map data (e.g., the criteria may indicate a threshold correspondence between the set of stairs as mapped using the predefined map data and the set of stairs as mapped using the live map data). The stair traversal authorization component 302 may determine if the second map data corresponds to (e.g., satisfies a threshold associated with) the map data. For example, the stair traversal authorization component 302 may compare the set of stairs as mapped by the second map data to the set of stairs as mapped by the map data.

In some cases, the stair traversal authorization component 302 may store data linking the set of stairs to the particular criteria. For example, the stair traversal authorization component 302 may access a data store that stores data linking one or more sets of stairs to one or more criteria (e.g., based on obtained instructions). The stair traversal authorization component 302 may obtain the particular criteria associated with the set of stairs based on (e.g., in response to) determining the environment includes the set of stairs.

In some cases, different sets of stairs may be associated with different criteria. For example, a first set of stairs having a first type of stairs (e.g., open riser stairs) may be associated with first criteria (e.g., a first threshold) and a second set of stairs having a second type of stairs (e.g., non-open riser stairs) may be associated with second criteria (e.g., a second threshold). By associating different sets of stairs with different criteria, the stair traversal authorization component 302 may account for particular sets of stairs being more difficult to navigate as compared to other sets of stairs. For example, a first set of open riser stairs with smaller treads as compared to a second set of non-open riser stairs may be more difficult for the robot 300 to navigate as compared to the second set of non-open risers stairs and the stair traversal authorization component 302 may use a larger threshold for the first set of open riser stairs as compared to a threshold for the second set of non-open riser stairs.

In some cases, a particular environment, a particular user, a particular robot, etc. may be associated with particular criteria. For example, a user operating the robot 300 may be associated with particular criteria such that the stair traversal authorization component 302 of the robot 300, identifies the user, identifies the criteria associated with the user, and reviews the stair model using the criteria.

Based on determining that the stair model satisfies the particular criteria, the stair traversal authorization component 302 may authorize the robot 300 to proceed with traversal of the environment (e.g., to traverse the set of stairs, to approach the set of stairs, etc.). For example, the stair traversal authorization component 302 may route instructions to the control system 370 authorizing the control system 370 to proceed with instructing traversal of the set of stairs by the robot 300. In another example, the stair traversal authorization component 302 may route instructions to the control system authorizing the control system to proceed with instructing traversal of an environment, by the robot 300, that includes a set of stairs (e.g., the robot 300 may not traverse the set of stairs as part of traversal of the environment).

In some cases, based on determining that the stair model satisfies the particular criteria, the stair traversal authorization component 302 may authorize a step planner to send a step plan to the control system 370 and instruct traversal of the environment. For example, the stair traversal authorization component 302 may route instructions (e.g., including the stair model) to the step planner to generate a step plan (e.g., based on the stair model) and route the step plan to the control system 370.

Based on determining that the stair model does not satisfy the particular criteria, the stair traversal authorization component 302 may not authorize the robot 300 to traverse the set of stairs, to approach the set of stairs, etc. For example, the stair traversal authorization component 302 may block (e.g., prohibit) the robot 300 from traversing the set of stairs, approaching the set of stairs, entering a location within a particular distance from the set of stairs (e.g., five centimeters, 20 centimeters, five meters, etc.).

Based on determining that the stair model does not satisfy the particular criteria, the stair traversal authorization component 302 may implement a contingency plan (e.g., an alternative method) to enable the building of a stair model that does satisfy the particular criteria. Based on determining that the stair model does not satisfy the particular criteria, the stair traversal authorization component 302 may instruct performance of a stair mapping maneuver (e.g., indicting how the robot 300 is to navigate within the environment) of the robot 300 within the environment. For example, the stair mapping maneuver may include an adjustment to a movement of the robot 300 (e.g., an adjustment to a step plan of the robot 300, an adjustment to an arm movement of the robot 300, etc.), an adjustment to how the robot 300 views the environment (e.g., while navigating the environment), etc. In another example, the stair mapping maneuver may include utilizing active gaze control of the robot 300 for perception of the set of stairs. In another example, the stair mapping maneuver may include an activation of one or more components (e.g., one or more sensors) of the robot 300.

In some cases, the stair mapping maneuver may include an adjustment to a gait of the robot 300 (e.g., from a trot to a crawl), a deceleration of the robot 300 (e.g., increasing a deceleration of the robot 300), a speed of the robot 300, etc. For example, the stair mapping maneuver may include an adjustment to a gait of the robot 300 to increase the safety of the robot while mapping the set of stairs. For example, the stair mapping maneuver may include instructing the robot 300 to implement a crawl gait (e.g., a statically stable crawl).

In some cases, the stair mapping maneuver may include a navigation by the robot 300 to a location in the environment associated with the set of stairs (e.g., navigation to a particular location with a particular field of view that includes the set of stairs). For example, the stair mapping maneuver may include navigation by the robot 300 to a goal region (e.g., a landing) associated with the set of stairs. In some cases, the stair mapping maneuver may include navigation by the robot 300 a particular location within the goal region.

In some cases, the stair mapping maneuver may include a movement by an appendage of the robot 300 (e.g., movement of an arm or a leg of the robot 300 to identify the set of stairs). For example, the stair mapping maneuver may include a movement to contact the set of stairs using a leg of the robot.

In some cases, the stair mapping maneuver may include an adjustment to a pose, an orientation, a position, a pitch, a height (e.g., a body height), or a swing (e.g., a leg swing height) of the robot 300. For example, the stair mapping maneuver may include an instruction for the robot 300 to stop navigation (e.g., to stand still) and to adjust a pitch of the robot 300.

In some cases, the stair mapping maneuver may include an adjustment to one or more sensors used by the robot 300 to view the environment, etc. For example, the stair mapping maneuver may include an activation of a sensor.

In some cases, the stair traversal authorization component 302 may determine a specific manner of performing a stair mapping maneuver. For example, the stair traversal authorization component 302 may determine a location (e.g., a goal region) within the environment to view the set of stairs (e.g., a location within a particular proximity range of the set of stairs) based on sensor data associated with the environment and the set of stairs and may instruct the robot 300 to navigate to the location. In another example, the stair traversal authorization component 302 may determine a deceleration (e.g., 2 meters per second squared), a gait, a speed (e.g., 0.35 meters per second), a pitch (e.g., a 45 degree pitch), etc. based on the sensor data associated with the environment and the set of stairs and may instruct the robot 300 to adjust the deceleration, the gait, the pitch, etc. of the robot 300 according to the determined deceleration, the determined gait, the determined pitch, etc. In another example, the stair traversal authorization component 302 may determine one or more sensors to view the environment (e.g., a sensor located on an arm, a sensor located on a front portion of the robot 300, etc.) based on the sensor data associated with the environment and the set of stairs and may instruct the robot 300 to move such that the one or more sensors are oriented to view the set of stairs. In another example, the stair traversal authorization component 302 (or a separate system) may determine a line segment associated with the set of stairs (e.g., in three-dimensional space) and may determine a pitch of the robot 300 that causes the line segment to be within a field of view of one or more sensors of the robot 300.

In some cases, the stair mapping maneuver may be stair-specific. For example, a first set of stairs may be associated with a first location for viewing the first set of stairs (e.g., one meter from a first riser of the first set of stairs and slightly to the left of a midline of the first set of stairs) such that the stair mapping maneuver includes navigation to the first location by the robot 300 and a second set of stairs may be associated with a second location for viewing the second set of stairs (e.g., 0.5 meters from a first edge of the second set of stairs and oriented with the midline of the second set of stairs) such that the stair mapping maneuver includes navigation to the second location by the robot 300. In another example, a first set of stairs may be a descending set of stairs (e.g., the robot 300 is located at the top of the first set of stairs and a navigation route of the robot 300 includes descent of the first set of stairs) and a second set of stairs may be an ascending set of stairs (e.g., the robot 300 is located at the bottom of the second set of stairs and a navigation route of the robot 300 includes ascent of the second set of stairs) such that the stair mapping maneuver relative to the first set of stairs includes an adjustment to a pitch of the robot 300 so that one or more sensors of the robot 300 point down the first set of stairs and the stair mapping maneuver relative to the second set of stairs includes an adjustment to a pitch of the robot 300 so that one or more sensors of the robot 300 point up the second set of stairs.

In some cases, one or more stair mapping maneuvers may not be valid adjustments for particular set of stairs (e.g., due to the nature of each set of stairs). For example, a stair mapping maneuver that includes movement of an appendage of the robot 300 (e.g., to feel for a first riser of the set of stairs) may be a valid stair mapping maneuver for an ascending set of stairs (e.g., as the robot 300 may be able to feel for the first riser) and may not be a valid stair mapping maneuver for a descending set of stairs (e.g., as the robot 300 may not be able to feel for the first riser).

The stair traversal authorization component 302 and the stair tracker 305 may form a feedback loop in that, based on the determination that the stair model does not satisfy the particular criteria, the stair traversal authorization component 302 may instruct performance of a stair mapping maneuver (e.g., an additional stair mapping maneuver) by the robot 300 and the stair tracker 305 may build an updated stair model. The stair tracker 305 may build the updated stair model and provide the updated stair model to the stair traversal authorization component 302.

The stair traversal authorization component 302 may not authorize the robot 300 to traverse the set of stairs until the stair traversal authorization component determines that the stair model, or the updated stair model, satisfies the particular criteria. For example, the stair traversal authorization component 302 may obtain (e.g., periodically or aperiodically) stair models from the stair tracker 305, may review the stair models to determine if the stair models satisfy the particular criteria, and, once the stair traversal authorization component 302 determines that the stair model satisfies the particular criteria, the stair traversal authorization component 302 may authorize the robot 300 to traverse the set of stairs.

In some cases, the stair traversal authorization component 302 may authorize the robot 300 to traverse the set of stairs based on a time period (e.g., a time out period). For example, the stair traversal authorization component 302 may instruct performance of one or more stair mapping maneuvers by the robot 300 (e.g., periodically, aperiodically, etc.) until the stair traversal authorization component 302 determines that a time period (e.g., 0.5 seconds, 5 seconds, 30 seconds, five minutes, ten minutes, etc.) has passed and the stair models (e.g., the updated stair models) do not satisfy the particular criteria. Based on the time period, the stair traversal authorization component 302 may authorize the robot to traverse the set of stairs using an adjusted manner of navigation (e.g., using a crawl gait, a statically stable crawl gait, etc.). For example, the stair traversal authorization component 302 may adjust a speed of the robot (e.g., to 0.2 meters per second, 0.1 meters per second, etc.) and may authorize the robot to traverse the set of stairs using the adjusted speed.

In some cases, the stair traversal authorization component 302 may authorize the robot 300 to traverse the set of stairs based on determining that an instructed stair mapping maneuver has not been performed (e.g., is unable to be performed). For example, the stair mapping maneuver may include navigation to a location within the environment to view the set of stairs and the stair traversal authorization component 302 may determine that the robot 300 cannot navigate to the location, has not navigated to the location within a time period (e.g., 5 seconds), and/or is not making progress in moving to the location within the time period (e.g., has not moved closer to the location within the time period). Based on determining that the instructed stair mapping maneuver has not been performed (e.g., and a time period has expired), the stair traversal authorization component 302 may authorize the robot to traverse the set of stairs using the adjusted manner of navigation.

In some cases, the stair traversal authorization component 302 may authorize the robot 300 to traverse the set of stairs based on determining that an instructed stair mapping maneuver has been performed. For example, the stair mapping maneuver may include navigation to a location within the environment to view the set of stairs and the stair traversal authorization component 302 may determine that the robot 300 has navigated to the location and has been at the location for a particular time period (e.g., 0.5 seconds). Based on determining that the instructed stair mapping maneuver has been performed (e.g., and a time period has expired), the stair traversal authorization component 302 may authorize the robot to traverse the set of stairs using the adjusted manner of navigation.

In some cases, the stair traversal authorization component 302 may determine that one or more models (e.g., including one or more updated stair models) do not satisfy the criteria and may not authorize traversal of the set of stairs. For example, the stair traversal authorization component 302 may determine that the one or more models generated by the stair tracker over a particular time period (e.g., five minutes) do not satisfy the criteria and, in response to determining that the one or more models do not satisfy the criteria (e.g., within a particular time period), the stair traversal authorization component 302 may not authorize the robot 300 to traverse the set of stairs (e.g., may instruct the robot 300 to not traverse the set of stairs).

In some cases, the stair traversal authorization component 302 may instruct provision of one or more alerts based on the stair traversal authorization component 302 not authorizing the robot 300 to traverse the set of stairs. For example, the stair traversal authorization component 302 may cause display of the one or more alerts via an output device of the robot 300 (e.g., a speaker of the robot 300, a display of the robot 300, etc.). In some cases, the stair traversal authorization component 302 may generate and provide the one or more alerts to a user computing device. For example, the stair traversal authorization component 302 may instruct display of the one or more alerts via a user interface of the user computing device. In some cases, the stair traversal authorization component 302 may generate an output (e.g., a fault) and provide the output to a system (e.g., a backend system) that may generate the alert.

In some cases, the stair traversal authorization component 302 may instruct navigation of the robot 300 to stop. For example, the stair traversal authorization component 302 may instruct the robot 300 to halt navigation based on determining that the one or more models do not satisfy the criteria (e.g., within a particular time period). In some cases, the stair traversal authorization component 302 may instruct generation of an updated navigation route that does not include traversal of the set of stairs and may instruct navigation of the robot according to the updated navigation route.

In some cases, the stair traversal authorization component 302 may authorize the robot 300 to traverse the set of stairs using an adjusted manner of navigation based on the particular criteria. The stair traversal authorization component 302 may determine that the stair model does not satisfy the particular criteria and may determine a relationship (e.g., a ratio, a percentage, a probability, a clarity, etc.) associated with the particular criteria and the stair model. For example, the stair traversal authorization component 302 may determine a ratio between a confidence metric associated with the stair model and a threshold confidence metric, a percentage associated with the stair model (e.g., a percentage of a feature that is included in the stair model, a percentage of the set of stairs indicated by the stair model, etc.), a probability that the stair model indicates the set of stairs (e.g., accurately and completely), etc.

Based on the relationship between the particular criteria and the stair model, the stair traversal authorization component 302 may adjust the manner of navigation for traversal of the set of stairs in a corresponding manner. For example, if the stair traversal authorization component 302 determines that a ratio between the criteria and the stair model is 95%, the stair traversal authorization component 302 may instruct the robot 300 to traverse the set of stairs using a speed decreased by 5% relative to a speed used by the robot 300 to traverse a non-stair portion of the environment, if the stair traversal authorization component 302 determines that a ratio between the criteria and the stair model is 50%, the stair traversal authorization component 302 may instruct the robot 300 to traverse the set of stairs using a speed decreased by 75% relative to the speed used by the robot 300 to traverse the non-stair portion of the environment, etc. In some cases, to determine how to adjust the manner of navigation for traversal of the set of stairs, the stair traversal authorization component 302 may compare the relationship to a threshold.

In some cases, the stair traversal authorization component 302 may a instruct performance of a stair mapping maneuver according to a hierarchical plurality of stair mapping maneuvers. All or a portion of the hierarchical plurality of stair mapping maneuvers may indicate a respective orientation and/or a respective position of the robot. The hierarchical plurality stair mapping maneuvers may indicate an order in which to perform a plurality of stair mapping maneuvers. For example, the order in which to perform the plurality of stair mapping maneuvers may be 1) to adjust a pose, orientation, position, etc. of the robot 300, 2) to instruct navigation of the robot 300 to one or more locations in the environment, 3) to instruct movement of an appendage of the robot 300 (e.g., to contact at least a portion of the set of stairs, and 4) to adjust a gait, a leg swing height, a deceleration, a body height, etc. of the robot 300.

The stair traversal authorization component 302 may instruct performance of at least a portion of the stair mapping maneuvers based on the order. For example, the robot 300 may first perform a first stair mapping maneuver that is ordered first based on the order, obtain an updated stair model based on performance of the first stair mapping maneuver, determine if the updated stair model satisfies the particular criteria, and, if the updated stair model satisfies the particular criteria, authorize traversal of the set of stairs, and, if the updated stair model does not satisfy the particular criteria, do not authorize traversal of the set of stairs and perform a second stair mapping maneuver that is ordered second based on the order.

In some cases, the stair traversal authorization component 302 may combine one or more stair mapping maneuvers. For example, the stair traversal authorization component 302 may instruct navigation of the robot 300 to a location within the environment and may instruct adjustment to a pose of the robot 300 once the robot 300 navigates to the location. In some cases, the stair traversal authorization component 302 may iteratively implement one or more stair mapping maneuvers. For example, the stair traversal authorization component 302 may identify a first time period for a first stair mapping maneuver and a second time period for a second stair mapping maneuver. The stair traversal authorization component 302 may implement the first adjustment during the first time period and the second adjustment during the second time period.

In some cases, the stair traversal authorization component 302 may not adjust the navigation of the robot 300. For example, as discussed herein, the stair traversal authorization component may obtain the stair model from the stair tracker 305, may determine that the stair model satisfies the particular criteria, and may authorize the robot 300 to proceed with traversal of the set of stairs using the stair model.

In some cases, based on determining that the stair model satisfies the particular criteria, the stair traversal authorization component 302 may adjust the manner of navigation of the robot 300 prior to authorizing the robot 300 to traverse the set of stairs. For example, the stair traversal authorization component 302 may instruct performance of a stair mapping maneuver that includes an adjustment of the manner of navigation of the robot from a first manner of navigation to a second manner of navigation based on determining that the stair model does not satisfy the particular criteria. Based on determining that an updated stair model does satisfy the particular criteria, the stair traversal authorization component 302 may readjust the manner of navigation (e.g., from the second manner of navigation back to the first manner of navigation, from the second manner of navigation to a third manner of navigation, etc.). For example, the robot 300 may navigate the environment at a first gait and the stair traversal authorization component 302 may adjust the gait from the first gait to a second gait (e.g., that is different as compared to the first gait) based on determining that the stair model does not satisfy the particular criteria. Based on determining that an updated stair model does satisfy the particular criteria, the stair traversal authorization component 302 may adjust the gait from the second gait to a third gait (e.g., that is different as compared to the first gait and the second gait).

In some cases, the stair traversal authorization component 302 may readjust the manner of navigation of the robot 300 during traversal of the set of stairs by the robot 300, after traversal of the set of stairs by the robot 300, etc. For example, the stair traversal authorization component 302 may readjust the manner of navigation of the robot 300 once the robot 300 indicates that the robot 300 is traversing the set of stairs.

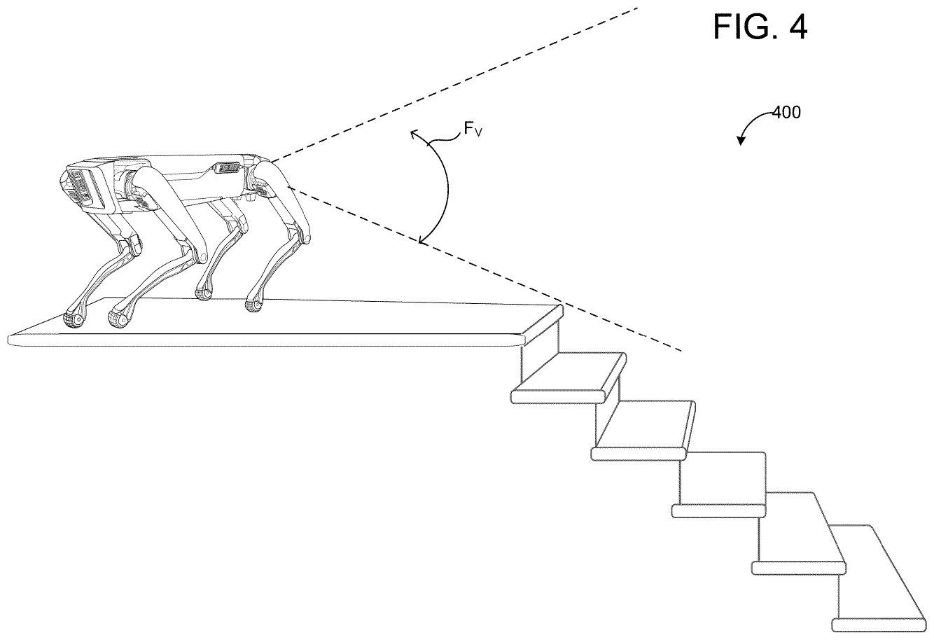

FIG. 4 is a schematic view 400 of a robot for navigating within an environment that includes a set of stairs. The robot may include and/or be similar to the robot 100 as discussed herein with reference to FIG. 1A, FIG. 1B, and FIG. 1C).

The environment may include a set of stairs and one or more landings associated with the set of stairs. For example, the environment may include a landing at the top of the set of stairs and a landing at the bottom of the set of stairs. In the example of FIG. 4, the environment includes a landing at the top of the set of stairs and the robot is located on the landing such that the set of stairs is a descending set of stairs relative to the robot (e.g., to traverse the set of stairs, the robot may descend the set of stairs).

The robot may have a field of view Fᵥ relative to the set of stairs. For example, all or a portion of the sensors of the robot may have a field of view Fᵥ relative to the set of stairs. The robot may have a limited field of view Fᵥ relative to the set of stairs in that all or portion of the set of stairs may be blocked (e.g., occluded) within the field of view Fᵥ. Based on the limited field of view Fᵥ, a stair model generated by the robot using sensor data obtained from sensors of the robot (e.g., based on the field of view Fᵥ) may be incomplete or partial (e.g., may not indicate one or more features of the set of stairs).

In the example of FIG. 4, one or more sensors located on a rear portion of the robot may have a field of view Fᵥ relative to the set of stairs and the field of view Fᵥ may not indicate and/or may not include one or more portions of the set of stairs. For example, the field of view Fᵥ may not indicate a first riser of the set of stairs (e.g., a riser of a first stair of the set of stairs, the first stair being the first stair traversed by the robot when descending the set of stairs and the last stair traversed by the robot when ascending the set of stairs), a second riser of the set of stairs (e.g., a riser of a second stair of the first set of stairs, the second stair being the second stair traversed by the robot when descending the set of stairs and a second to last stair traversed by the robot when ascending the set of stairs), a second tread or edge of the set of stairs (e.g., a tread or an edge of the second stair), etc.

In some cases, classification of a first edge, a first riser, a first tread, a first stair, a second edge, a second riser, a second tread, a second stair, etc. may change based on whether the robot is ascending a set of stairs (e.g., is located at the bottom of the set of stairs) or is descending the set of stairs (e.g., is located at the top of the set of stairs). For example, a first stair for a descending set of stairs may be the last stair for an ascending set of stairs.

A computing system of the robot (e.g., the stair traversal authorization component 302 as discussed herein with reference to FIG. 3) may compare the stair model to one or more criteria. Based on comparing the stair model to the one or more criteria (and determining that the stair model does not satisfy the one or more criteria), the computing system may pause navigation of the robot (e.g., may pause traversal of the set of stairs) and may instruct performance of a stair mapping maneuver the robot (e.g., to obtain an updated stair model).

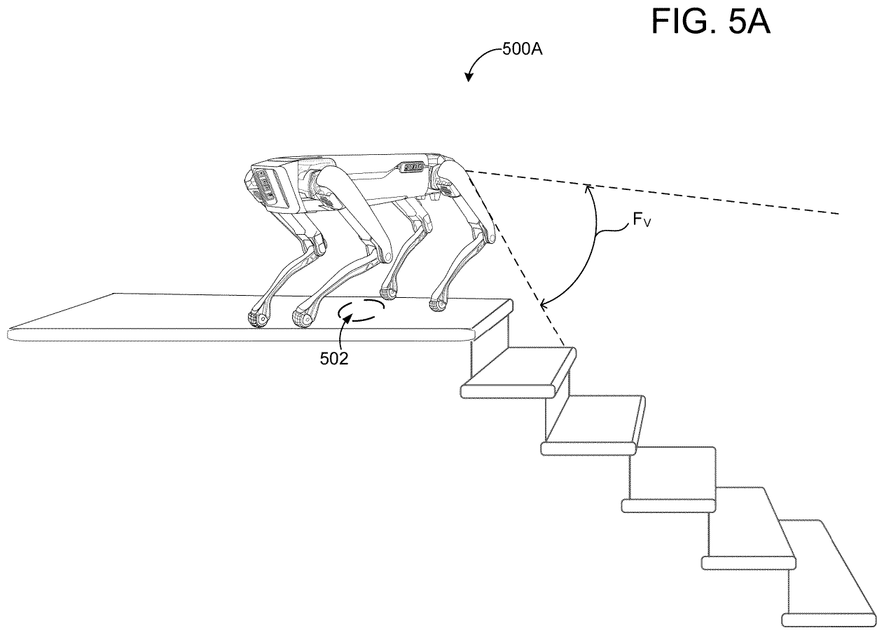

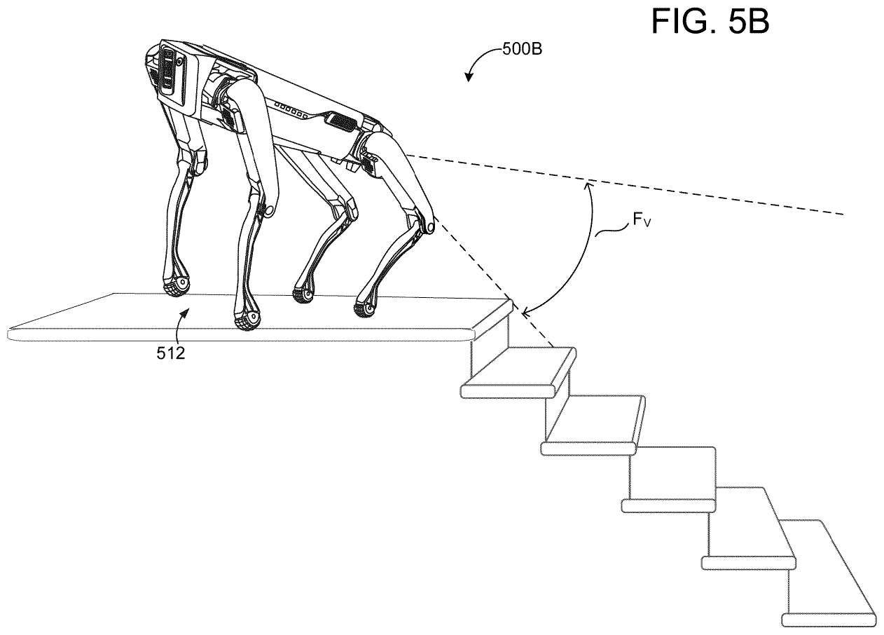

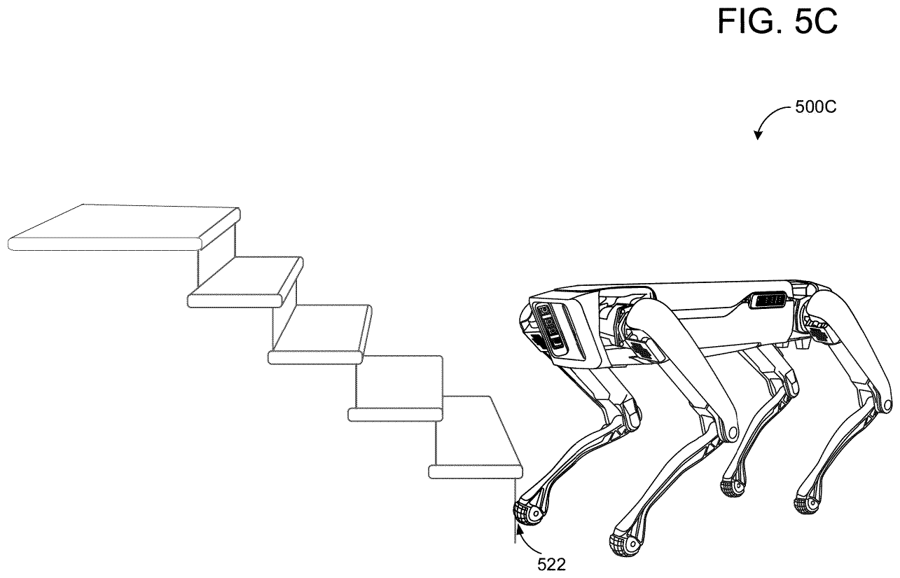

To provide examples of stair mapping maneuvers, FIG. 5A, FIG. 5B, and FIG. 5C may each be a schematic view of a robot based on execution of a stair mapping maneuver. The robot may include and/or be similar to the robot 100 as discussed herein with reference to FIG. 1A, FIG. 1B, and FIG. 1C). The stair mapping maneuvers may be identified and implemented by a computing system of the robot (e.g., the stair traversal authorization component 302 as discussed herein with reference to FIG. 3).

FIG. 5A is a schematic view 500B of a robot based on execution of a stair mapping maneuver 502. To implement the stair mapping maneuver 502, the computing system may identify a location (e.g., located separate from and/or prior to the set of stairs) within the environment (e.g., associated with the set of stairs and a field of view Fᵥ of the robot). For example, the computing system may determine a location such that computing system predicts that the field of view Fᵥ of the robot located at the location may include one or more features (e.g., portions) of the set of stairs (e.g., a first riser, a first edge, etc.).

To implement the stair mapping maneuver 502, the computing system may instruct movement by the robot to the location. In some cases, the computing system may adjust a navigation route to include the location. In some cases, the computing system may generate and/or adjust a step plan of the robot to include the location.

In some cases, as the set of stairs is a descending set of stairs, to implement the stair mapping maneuver 502, the computing system may instruct the robot to move to the location and orient backwards as shown in FIG. 5A (e.g., such that a rear portion of the robot faces the set of stairs as the robot may traverse the descending set of stairs backwards). For a robot oriented backwards, a knee joint of the legs of the robot may be located closer to the set of stairs as compared to a hip joint of the legs of the robot (e.g., when the robot is standing). In some cases, the computing system may instruct the robot to first move to the location and second orient backwards (e.g., relative to the set of stairs). In some cases, the computing system may instruct the robot to first orient backwards and second move to the location. In some cases, the computing system may instruct the robot to simultaneously orient backwards and move to the location.

In the example of FIG. 5A, the stair mapping maneuver 502 includes navigation to a location prior to the set of stairs. The location may be located along a centerline of the set of stairs (e.g., such that the field of view Fᵥ of the robot is based on the centerline of the set of stairs).

FIG. 5B is a schematic view 500B of a robot based on execution of a stair mapping maneuver 512. To implement the stair mapping maneuver 512, the computing system may identify a pose, orientation, position, etc. of the robot. For example, the computing system may determine a pose, orientation, position, etc. of the robot such that computing system predicts that the field of view Fᵥ of the robot configured according to the determined pose, orientation, position, etc. may include one or more features (e.g., portions) of the set of stairs (e.g., a first riser, a first edge, etc.).

To implement the stair mapping maneuver 512, the computing system may instruct movement by the robot according to the determined pose, orientation, position, etc. For example, the computing system may instruct movement by one or more legs of the robot to adjust a pose, orientation, position, etc. of the robot according to the determined pose, orientation, position, etc.

In some cases, as the set of stairs is a descending set of stairs, to implement the stair mapping maneuver 512, the computing system may instruct the robot to move to the location and orient rearwards (e.g., such that a rear portion of the robot faces the set of stairs as the robot may traverse the ascending set of stairs rear first).

In the example of FIG. 5B, the stair mapping maneuver 512 includes an adjustment to a pose of the robot (e.g., an adjustment to a pitch of the robot). The adjustment to a pose of the robot may include adjusting a front portion of the robot up and/or adjusting a rear portion of the robot down.

FIG. 5C is a schematic view 500C of a robot based on execution of a stair mapping maneuver 522. To implement the stair mapping maneuver 522, the computing system may instruct movement of one or more appendages of the robot. For example, the computing system may instruct movement of a leg, an arm, etc. of the robot to feel for a portion of the set of stairs (e.g., a first riser, a first edge, etc.).

Based on instructing movement of one or more appendages of the robot, the computing system may determine contact by the one or more appendages with all or a portion of the set of stairs. Based on the determined contact by the one or more appendages, the computing system may map a feature of the set of stairs (e.g., a location of a first riser of the set of stairs) within a stair model.

In the example of FIG. 5C, the stair mapping maneuver 522 includes a movement by a leg of the robot (e.g., to feel for a first riser of the set of stairs.). As shown in FIG. 5C, the computing system may instruct the leg to move and the computing system may determine that a distal end of the leg contacts the first riser of the set of stairs based on the movement of the leg.

As discussed herein with reference to FIG. 5A, FIG. 5B, and FIG. 5C, a computing system of the robot (e.g., the stair traversal authorization component 302 as discussed herein with reference to FIG. 3) may instruct performance of a stair mapping maneuver and may obtain an updated stair model of the robot. The computing system may compare the updated stair model to one or more criteria and may determine that the updated stair model satisfies the one or more criteria. In some cases, the computing system may iteratively instruct performance of one or more stair mapping maneuvers by the robot, obtain an updated stair model, and compare the updated stair model to the one or more criteria.

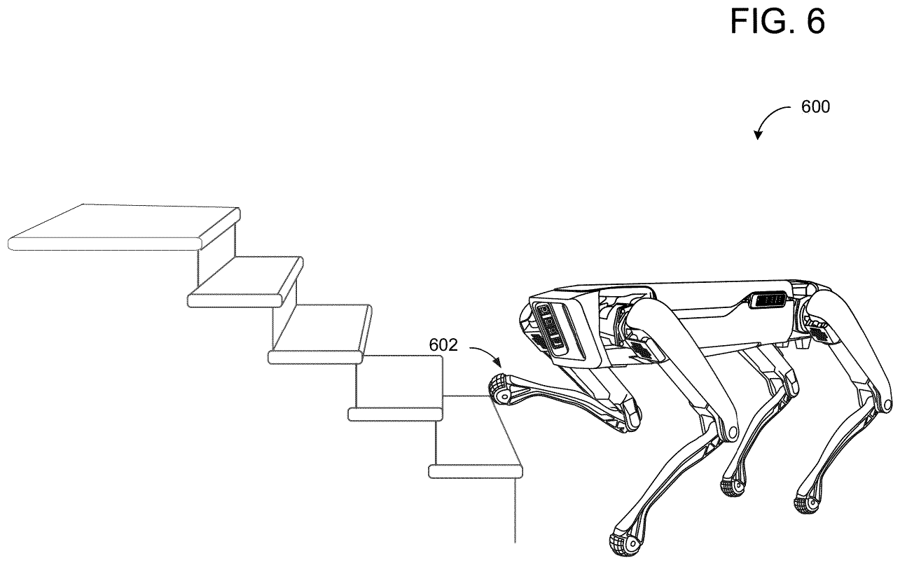

Based on determining that the stair model (e.g., an original stair model, an updated stair model, etc.) satisfies one or more criteria, the computing system may authorize traversal of the set of stairs by the robot (e.g., may instruct traversal of the set of stairs by the robot). FIG. 6 is a schematic view 600 of a robot 602 navigating a set of stairs. The robot 602 may include and/or be similar to the robot 100 as discussed herein with reference to FIG. 1A, FIG. 1B, and FIG. 1C). Traversal of the set of stairs may be authorized by a computing system of the robot (e.g., the stair traversal authorization component 302 as discussed herein with reference to FIG. 3).

The computing system may authorize traversal of the set of stairs by the robot 602 according to and/or based on the determined stair model (e.g., indicating one or more features of the set of stairs). For example, the computing system may route authorization and/or a step plan based on the determined stair model to a control system of the robot 602 and the control system may instruct traversal of the set of stairs by the robot 602 (e.g., based on mission data).

To instruct traversal of the set of stairs, the control system may identify one or more locations for placement of one or more distal ends of one or more legs of the robot (e.g., according to a step plan). The control system may instruct movement of the one or more distal ends of the one or more legs to the one or more identified locations.

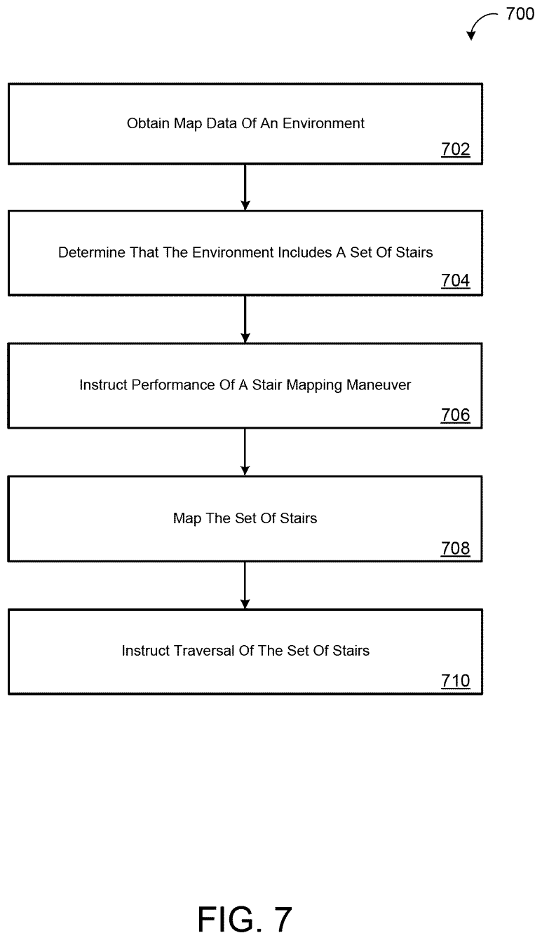

FIG. 7 is a flowchart 700 of an example arrangement of operations for a computing system for mapping a set of stairs and instructing traversal of the set of stairs by a robot. For example, the robot may be a legged robot with a set of legs (e.g., two or more legs, four or more legs, etc.), memory, and a processor. Further, the computing system may be a computing system of the robot. In some cases, the computing system of the robot may be located on and/or part of the robot. In some cases, the computing system of the robot may be distinct from and located remotely from the robot. For example, the computing system of the robot may communicate, via a local network, with the robot. The computing system may include and/or may be similar, for example, to the stair traversal authorization component 302 as discussed herein, and may include memory and/or data processing hardware.

At block 702, the computing system obtains map data (e.g., one or more maps) associated with an environment (e.g., a map of the environment of the robot). In some cases, the map data may map a set of stairs. The map data may include pre-recorded map data (e.g., map data recorded during an initial mapping operation, during an initial, separate navigation by the robot through the environment, etc.). The map data may include an approximation of the location of the set of stairs (e.g., an expected location of the set of stairs).

The computing system may obtain the map data from another computing system (e.g., a computing system of the robot). In some cases, the computing system may generate the map data.

At block 704, the computing system determines that the environment includes a set of stairs. For example, the computing system may determine that the environment includes the set of stairs based on the map data. In some cases, the computing system may determine that the environment includes at least a portion of the set of stairs (e.g., a first riser, a first tread, etc.). In some cases, the computing system may determine that the environment includes a set of stairs based on a first stair model.

In some cases, the computing system may identify (e.g., obtain) mission data associated with the robot. For example, the mission data may be indicative of a mission of the robot, a navigation route of the robot, etc. The computing system may determine that the mission data is associated with the set of stairs (e.g., that the mission and/or navigation route includes and/or includes traversal of the set of stairs). The computing system may determine that the environment includes the set of stairs based on determining that the mission data is associated with the set of stairs (e.g., based on determining that the navigation route includes traversal of the set of stairs).

A first portion of the set of stairs may be occluded (e.g., blocked) from a field of view of a sensor of the robot and a second portion of the set of stairs may not be occluded from the field of view. In some cases, all or a portion of the set of stairs may be occluded from the field of view.

At block 706, the computing system instructs performance of a stair mapping maneuver (e.g., of the robot, by the robot, etc.). For example, the computing system may instruct performance of the stair mapping maneuver based on determining that the environment includes the set of stairs (e.g., based on determining that the mission data is associated with the set of stairs). In some cases, the computing system may instruct performance of the stair mapping maneuver based on (e.g., using) a cost function (e.g., to identify a particular pose for the robot).

In some cases, the computing system may obtain sensor data (e.g., from a sensor of the robot) associated with the set of stairs. The computing system may instruct performance of the stair mapping maneuver based on the sensor data (e.g., based on the sensor data indicating a field of view of the robot is occluded).

In some cases, the computing system may construct a stair model (e.g., a first stair model) based on the sensor data (e.g., a live stair model), may determine that the stair model does not satisfy one or more criteria, and may instruct performance of the stair mapping maneuver. Further, the computing system may determine that the stair model does not satisfy the one or more criteria based on determining that the stair model does not map one or more features of the set of stairs.

In some cases, the computing system may determine that the map data (e.g., the predefined map data used to determine that the environment may include a set of stairs) does not satisfy the one or more criteria (e.g., a stair model of the map data does not satisfy the one or more criteria) and may instruct performance of the stair mapping maneuver. While the map data may map the set of stairs, as the map data may be pre-recorded (e.g., during an initial mapping mission), the map data may not be accurate and/or may be out-of-date, such that the computing system instructs performance of a stair mapping maneuver to generate second map data mapping the one or more features of the set of stairs (e.g., using the stair model) which may be more accurate as compared to the map data.

In some cases, the computing system may obtain sensor data based on instructing performance of the stair mapping maneuver. For example, the stair mapping maneuver may include navigation to a location within the environment and the computing system may obtain sensor data based on instructing navigation to the location and/or confirming navigation by the robot to the location. In some cases, the computing system may obtain sensor data based on determining that the stair mapping maneuver has been performed by the robot (e.g., based on determining that the stair mapping maneuver is completed),

In some cases, to instruct performance of the stair mapping maneuver, the computing system may adjust a manner of navigation of the robot from a first manner of navigation to a second manner of navigation. In some cases, a first portion of the set of stairs may be occluded with respect to the field of view based on the first manner of navigation and a second portion of the set of stairs may be occluded with respect to the field of view based on the second manner of navigation (e.g., the first portion may exceed, may be greater than, etc. the second portion). In some cases, a first portion of the set of stairs may be occluded with respect to the field of view based on the first manner of navigation and the set of stairs may be within the field of view based on the second manner of navigation.

In some cases, to instruct performance of the stair mapping maneuver, the computing system may instruct movement (e.g., navigation) by the robot to a location within the environment (e.g., to a portion of the environment). For example, the computing system may instruct movement by the robot to a landing, a top, a bottom, etc. of the set of stairs.

In some cases, the computing system may identify and/or determine the location within the environment. For example, the computing system may identify and/or determine (e.g., using sensor data associated with the environment) the location to identify and/or view the set of stairs.

In some cases, to instruct performance of the stair mapping maneuver, the computing system may instruct deviation by the robot from a step plan, a route edge (e.g., connecting a first route waypoint and a second route waypoint), a navigation route (e.g., indicating a set of route waypoints connected using a set of route edges), etc. of the robot.

In some cases, the computing system may verify the movement by the robot. For example, the computing system may determine a location using first sensor data, may instruct movement by the robot to the location, may verify movement by the robot to the position (e.g., based on sensor data associated with the robot), and may obtain second sensor data based on the movement and/or based on verifying the movement.

In some cases, to instruct performance of the stair mapping maneuver, the computing system may adjust (e.g., may instruct adjustment) of one or more of an orientation of the robot, a position of the robot, and/or a pose of the robot. For example, the computing system may determine (e.g., using first sensor data) an orientation of the robot, a position of the robot, and/or a pose of the robot and may instruct adjustment of the robot based on the determined orientation, position, and/or pose (e.g., by adjusting the orientation, position, and/or pose of the robot according to the determined orientation, position, and/or pose). The computing system may obtain second sensor data based on the instructing the adjustment, the adjustment, and/or based on verifying the adjustment. In some cases, the computing system may verify the adjustment.

In some cases, to instruct performance of the stair mapping maneuver, the computing system may instruct movement of one or more appendages of the robot (e.g., a leg, an arm, etc.). Based on instructing the movement of the one or more appendages, the computing system may obtain sensor data (e.g., force sensor data) from one or more sensors (e.g., one or more force sensors) of the robot and determine that the one or more appendages contact at least a portion of the set of stairs based on the sensor data.

In some cases, to instruct performance of the stair mapping maneuver, the computing system may adjust one or more of a speed of the robot (e.g., adjust the speed to 0.35 meters per second), a gait of the robot, a swing of the robot, a deceleration of the robot (e.g., adjust the deceleration to 2 meters per second squared), etc.

In some cases, to instruct performance of the stair mapping maneuver, the computing system may adjust a field of view of the robot. For example, the computing system may adjust a field of view of a sensor of the robot.

In some cases, the computing system may iteratively instruct performance of two or more stair mapping maneuvers. For example, the computing system may first instruct movement by the robot to a location within the environment and second may instruct adjustment of one or more of an orientation of the robot, a position of the robot, and/or a pose of the robot based on instructing movement by the robot to the location.

At block 708, the computing system maps the set of stairs (e.g., based on the sensor data). To map the set of stairs, the computing system may identify one or more of a riser, a landing, a tread, etc. of the set of stairs.

The computing system may generate second map data (e.g., real time, live map data) and may map the set of stairs using the second map data. For example, the second map data may include a stair model (e.g., mapping the set of stairs to sensor data, to the environment, etc.). In some cases, the map data may be predefined map data and the second map data may be live map data. In some cases, the map data and the second map data may be generated during different missions, different time periods, etc.

In some cases, the computing system may obtain sensor data based on performance of the stair mapping maneuver, may build a stair model of the second map data based on the sensor data, and may identify the set of stairs using the stair model. For example, the computing system may obtain the sensor data (e.g., second sensor data) from a sensor of the robot based on instructing movement by the robot, based on movement by the robot, movement by one or more appendages of the robot and contact with at least a portion of the set of stairs, adjustment of a pose, orientation, position, etc. of the robot, etc.). For example, the sensor data may include one or more of image data or pressure data. The computing system may map the set of stairs based on (e.g., using) the sensor data.

In some cases, the computing system may map the set of stairs based on (e.g., using) a stair model (e.g., an updated stair model). For example, a stair tracker of the robot may generate and provide a stair model based on the sensor data to the computing system. In some cases, the computing system may map the set of stairs based on the stair model and the sensor data.

In some cases, the computing system may obtain the stair model associated with the set of stairs (e.g., may construct the stair mode using the obtained sensor data) based on instructing performance of the stair mapping maneuver and may compare the stair model to one or more criteria (e.g., one or more thresholds indicating a threshold clarity metric, a threshold confidence metric, a threshold feature metric, a threshold quality metric, a threshold precision metric, a threshold accuracy metric, etc.). For example, the computing system may determine one or more metrics (e.g., a clarity metric, a confidence metric, a feature metric, a quality metric, a precision metric, an accuracy metric, etc.) associated with the stair and may compare the one or more metrics to the one or more criteria (e.g., to verify that the one or more metrics satisfy a threshold). The computing system may determine the one or more criteria are associated with the set of stairs and may compare the one or more criteria with the stair model based on determining the one or more criteria are associated with the set of stairs. For example, the one or more criteria may indicate a riser of the set of stairs (e.g., a first riser) and the computing system may determine that the stair model maps the riser. In another example, the one or more criteria may indicate that a mapping of the set of stairs should include a mapping for a particular portion of the set of stairs (e.g., a riser). In another example, the one or more criteria may indicate that a field of view of a sensor of the robot should include a portion of the set of stairs.

In some cases, the computing system may determine that the stair model satisfies the one or more criteria (e.g., the set of stairs is not occluded) and may instruct traversal of the set of stairs based on determining that the stair model satisfies the one or more criteria.

The computing system may instruct performance of the stair mapping maneuver based on determining that the stair model does not satisfy the one or more criteria (e.g., based on determining that at least a portion of the set of stairs are occluded, determining that a field of view of a sensor of the robot does not include a portion of the set of stairs, etc.). For example, based on determining that the stair model does not satisfy the one or more criteria, the computing system may determine that at least a portion of the set of stairs is occluded with respect to the field of view and may instruct performance of the stair mapping maneuver.

In some cases, the computing system may determine that the stair model does not satisfy the one or more criteria (e.g., that at least a portion of the set of stairs is occluded with respect to the field of view). Based on determining that the stair model does not satisfy the one or more criteria, the computing system may generate an alert (e.g., indicating that the stair model does not satisfy the one or more criteria) and may route the alert to a computing system (e.g., a user computing device).

In some cases, the computing system may obtain an updated stair model (e.g., from a stair tracker) associated with the set of stairs and based on sensor data (e.g., sensor data based on performance of the stair mapping maneuver). The computing system may compare the updated stair model to the one or more criteria.

Based on determining that the updated stair model does not satisfy the one or more criteria (e.g., based on the computing system determining that at least a portion of the set of stairs are occluded with respect to a field of view of one or more sensors, the computing system mapping a first portion of the set of stairs within the stair model but not mapping a second portion of the set of stairs, etc.), the computing system may instruct performance of an additional stair mapping maneuver and may obtain a further updated stair model. The computing system may determine that a further updated stair model satisfies the one or more criteria. For example, the computing system may determine that at least a portion of the set of stairs are not occluded with respect to the field of view, the computing system may identify a second portion of the set of stairs, etc. based on the further updated stair model.

In some cases, based on determining that a stair model (e.g., an updated stair model) does not satisfy the one or more criteria, the computing system may identify why the stair model does not satisfy the one or more criteria. For example, the computing system may identify that the stair model does not satisfy the one or more criteria because the stair model maps a first portion of the set of stairs (e.g., a first railing, a first riser, etc.) but not a second portion of the set of stairs (e.g., a second railing, a second riser, etc.). The computing system may identify an additional stair mapping maneuver based on identifying why the stair model does not satisfy the one or more criteria. For example, the computing system may identify an additional stair mapping maneuver to navigate a robot to a location based on determining that the stair model maps a first portion of the set of stairs but not a second portion of the set of stairs and predicting that the second portion of the set of stairs will be within a field of the view of a sensor of the robot located at the location.

Based on determining that the updated stair model does satisfy the one or more criteria, the computing system may validate (e.g., verify) the updated stair model for traversal of the set of stairs. For example, the computing system may verify that the updated stair model satisfies the one or more criteria (e.g., that a portion of the set of stairs mapped in the updated stair model satisfies the one or more criteria). In another example, based on determining that environment includes a set of stairs and that the updated stair model does satisfy the one or more criteria, the computing system may obtain sensor data associated with a sensor of the robot and may verify that the sensor data indicates the set of stairs.

In some cases, the computing system may iteratively instruct performance of two or more stair mapping maneuvers until the computing system determines a corresponding updated stair model satisfies the one or more criteria. For example, the computing system may instruct iterative performance of a hierarchical plurality of stair mapping maneuvers. In some cases, the computing system may iteratively instruct performance of two or more stair mapping maneuvers until a time period satisfies a threshold and/or a number of performed stair mapping maneuvers or stair models satisfies a threshold.

For example, the computing system may generate a first stair model based on performance of a first stair mapping maneuver (e.g., the first stair model may map a first portion of the set of stairs to the first sensor data) and may determine that the first stair model does not satisfy one or more criteria. For example, the computing system may determine that the first stair model does not map a second portion of the set of stairs (e.g., a first riser). Based on determining that the first stair model does not satisfy the one or more criteria, the computing system may identify a second stair mapping maneuver (e.g., may adjust a stair mapping maneuver for performance by the robot from the first stair mapping maneuver to the second stair mapping maneuver). To map the set of stairs, the computing system may generate a second stair model based on performance of the second stair mapping maneuver (e.g., the second stair model may map a second portion of the set of stairs to second sensor data) and may determine that the second stair model satisfies the threshold. For example, different portions of the set of stairs may be mapped based on the performance of the first stair mapping maneuver and the second stair mapping maneuver.

In some cases, the computing system may obtain a first portion of the sensor data based on performance of a first stair mapping maneuver and a second portion of the sensor data based on performance of a second stair mapping maneuver. The computing system may generate the stair model using the first portion of the sensor data and the second portion of the sensor data (e.g., as combined).

At block 710, the computing system instructs traversal of the set of stairs (e.g., by the robot). The computing system may instruct traversal of the set of stairs based on identifying the set of stairs, based on verifying that sensor data indicates the set of stairs, etc. For example, the computing system may instruct traversal of the set of stairs based on verifying that the second map data (e.g., the stair model of the second map data) satisfies one or more criteria (e.g., a threshold). In some cases, the computing system may not instruct traversal of the set of stairs, instead, the computing system may authorize another system of the robot (e.g., a control system) to instruct traversal of the set of stairs.

In some cases, the computing system may instruct traversal of the set of stairs based on determining that a stair model (e.g., an initial stair model, an updated stair model, etc.) satisfies the one or more criteria and validating (e.g., verifying) the stair model for traversal of the set of stairs. For example, the computing system may instruct traversal of the set of stairs based on verifying that the updated stair model satisfies the one or more criteria (e.g., that an amount of the set of stairs mapped using the updated stair model satisfies the one or more criteria).

As discussed herein, based on mapping the set of stairs, the computing system may adjust a manner of navigation of the robot. The computing system may instruct traversal of the set of stairs according to the adjusted manner of navigation.

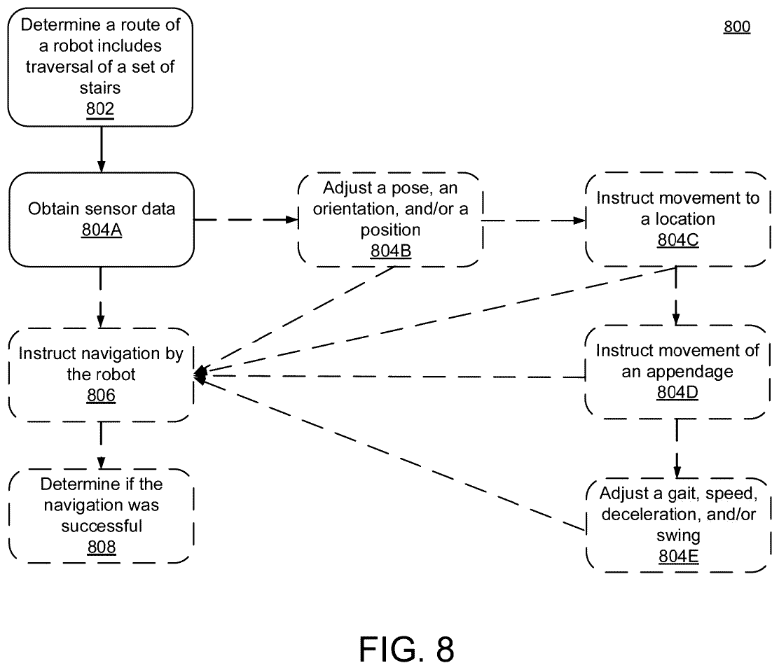

FIG. 8 is an operation diagram 800 for mapping a set of stairs and instructing traversal of the set of stairs. A computing system may implement the steps of the operation diagram 800 and may include and/or may be similar, for example, to the stair traversal authorization component 302 as discussed herein, and may include memory and/or data processing hardware. The operation diagram 800 may indicate example steps for authorizing traversal of a set of stairs based on determining that an environment includes the set of stairs.

At step 802, the computing system determines that a route (e.g., a navigation route) of a robot includes traversal of a set of stairs. For example, as discussed herein, the computing system may determine that the navigation route includes traversal of the set of stairs based on mission data.

At step 804A, the computing system obtains sensor data associated with an environment. The computing system may obtain the sensor data from one or more sensors. The computing system may obtain a stair model based on the sensor data and may compare the stair model to one or more criteria based on determining that the environment includes a set of stairs. If the computing system determines that the stair model satisfies the one or more criteria, the computing system may proceed to step 806. If the computing system determines that the stair model does not satisfy the one or more criteria, the computing system may proceed to step 804B (and may instruct performance of one or more stair mapping maneuvers the robot). All or a portion of Steps 804B, 804C, 804C, 804D, and 804E may correspond to stair mapping maneuvers as discussed herein.

At step 804B, the computing system may adjust a pose, an orientation, and/or a position of the robot. The computing system may obtain further sensor data from the one or more sensors based on adjusting the pose, the orientation, and/or the position. The computing system may obtain an updated stair model based on the further sensor data and may compare the updated stair model to the one or more criteria. If the computing system determines that the updated stair model satisfies the one or more criteria, the computing system may proceed to step 806. If the computing system determines that the updated stair model does not satisfy the one or more criteria, the computing system may proceed to step 804C.

At step 804C, the computing system may instruct movement by the robot to a location in the environment. In some cases, the computing system may identify the location in the environment based on a location of the set of stairs (e.g., as indicated by the map data) and a location of one or more obstacles, entities, structures, and/or objects in the environment (e.g., as indicated by second map data that may include a local obstacle map). For example, the map data may indicate an approximate location of the set of stairs within the environment. The computing system may use the location of the set of stairs and the location of the one or more obstacles, entities, structures, and/or objects to determine a location to view the set of stairs. For example, the computing system may use one or more cost functions to determine the location. In some cases, the computing system may identify a pose to implement at the location. Based on determining the location, the computing system may plan and instruct navigation according to a step plan to navigate to the location.

The computing system may obtain further sensor data from the one or more sensors based on instructing movement by the robot to the location. The computing system may obtain an updated stair model based on the further sensor data and may compare the updated stair model to the one or more criteria. If the computing system determines that the updated stair model satisfies the one or more criteria, the computing system may proceed to step 806. If the computing system determines that the updated stair model does not satisfy the one or more criteria, the computing system may proceed to step 804D.

At step 804D, the computing system may instruct movement of an appendage of the robot. For example, the computing system may instruct the robot to move the appendage and feel for the set of stairs. The computing system may obtain further sensor data from the one or more sensors based on instructing movement of the appendage. The computing system may obtain an updated stair model based on the further sensor data and may compare the updated stair model to the one or more criteria. If the computing system determines that the updated stair model satisfies the one or more criteria, the computing system may proceed to step 806. If the computing system determines that the updated stair model does not satisfy the one or more criteria, the computing system may proceed to step 804E.

At step 804E, the computing system may adjust a gait, a speed, a deceleration, and/or a swing of the robot. For example, the computing system may instruct the robot to proceed with caution. The computing system may obtain further sensor data from the one or more sensors based on adjusting the gait, the speed, the deceleration, and/or the swing of the robot. The computing system may obtain an updated stair model based on the further sensor data and may compare the updated stair model to the one or more criteria. If the computing system determines that the updated stair model satisfies the one or more criteria, the computing system may proceed to step 806.

In some cases, if the computing system determines that the updated stair model does not satisfy the one or more criteria, the computing system may not proceed to step 806 and may generate an alert and route the alert to a user computing device. In some cases, if the computing system determines that the updated stair model does not satisfy the one or more criteria, the computing system may further adjust a gait, a speed, a deceleration, and/or a swing of the robot and traverse the set of stairs. For example, the computing system may instruct the robot to proceed with traversal of the set of stairs with caution.

In some cases, the computing may receive an input (e.g., from a user computing device). For example, the input may indicate an order of the hierarchical plurality of stair mapping maneuvers (e.g., first adjust an orientation of the robot and, if the stair model based on adjusting the orientation of the robot does not satisfy the one or more criteria, second instruct movement of a leg of the robot). In another example, the input may indicate a response to determining that the updated stair model does not satisfy the one or more criteria (e.g., proceed with traversal of the set of stairs with caution, stop navigation, generate and route an alert, etc.).

At step 806, the computing system may instruct navigation by the robot within the environment. For example, the computing system may instruct traversal of the set of stairs.

At step 808, the computing system may determine if the navigation by the robot was successful. For example, the computing system may determine if the robot navigated from a first portion of the set of stairs (e.g., a bottom of the set of stairs) to a second portion of the set of stairs (e.g., a top of the set of stairs) within a threshold time period (e.g., five minutes). The computing system may determine if the navigation by the robot was successful based on sensor data (e.g., location data) associated with the robot.

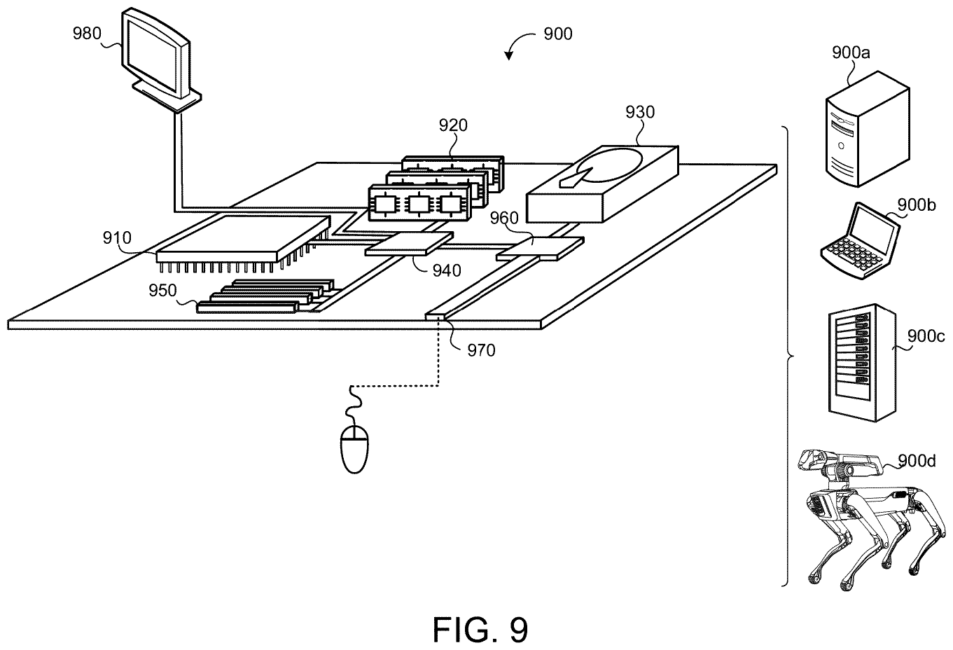

FIG. 9 is schematic view of an example computing device 900 that may be used to implement the systems and methods described in this document. The computing device 900 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 900 includes a processor 910, memory 920 (e.g., non-transitory memory), a storage device 930, a high-speed interface/controller 940 connecting to the memory 920 and high-speed expansion ports 950, and a low-speed interface/controller 960 connecting to a low-speed bus 970 and a storage device 930. All or a portion of the processor 910, the memory 920, the storage device 930, the high-speed interface/controller 940, and/or the high-speed expansion ports 950 may be interconnected using various busses, and may be mounted on a common motherboard or in other manners as appropriate. The processor 910 can process instructions for execution within the computing device 900, including instructions stored in the memory 920 or on the storage device 930 to display graphical information for a graphical user interface (GUI) on an external input/output device, such as display 980 coupled to the high-speed interface/controller 940. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 920 stores information non-transitorily within the computing device 900. The memory 920 may be a computer-readable medium, a volatile memory unit(s), or non-volatile memory unit(s). The memory 920 may be physical devices used to store programs (e.g., sequences of instructions) or data (e.g., program state information) on a temporary or permanent basis for use by the computing device 900. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 930 is capable of providing mass storage for the computing device 900. In some implementations, the storage device 930 is a computer-readable medium. In various different implementations, the storage device 930 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described herein. The information carrier is a computer- or machine-readable medium, such as the memory 920, the storage device 930, or memory on processor 910.

The high-speed interface/controller 940 may manage bandwidth-intensive operations for the computing device 900, while the low-speed interface/controller 960 may manage lower bandwidth-intensive operations. Such allocation of duties is exemplary only. In some implementations, the high-speed interface/controller 940 may be coupled to the memory 920, the display 980 (e.g., through a graphics processor or accelerator), and to the high-speed expansion ports 950, which may accept various expansion cards (not shown). In some implementations, the low-speed interface/controller 960 may be coupled to the storage device 930 and a low-speed expansion port. The low-speed expansion port, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 900a or multiple times in a group of such servers, as a laptop computer 900b, as part of a rack server system 900c, or as part of a robot 900d (which may include and/or be similar to the robot 100 as discussed herein with reference to FIG. 1A, FIG. 1B, and FIG. 1C).

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user. In some cases, interaction is facilitated by a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, and/or tactile feedback; and input from the user can be received in any form, including acoustic, speech, and/or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times. Furthermore, the elements and acts of the various embodiments described herein can be combined to provide further embodiments. Indeed, the methods and systems described herein may be embodied in a variety of other forms; furthermore, various omissions, substitutions, and changes in the form of the methods and systems described herein may be made without departing from the spirit of the disclosure. Accordingly, other implementations are within the scope of the following claims.

What is claimed is:

1. A method comprising:
obtaining, by data processing hardware of a robot, a map of an environment of the robot;
determining, by the data processing hardware, based on the map, that the environment comprises a set of stairs;
instructing, by the data processing hardware, performance of a stair mapping maneuver by the robot based on determining that the environment comprises the set of stairs;
obtaining, by the data processing hardware, first sensor data based on the performance of the stair mapping maneuver;
mapping, by the data processing hardware, the set of stairs based on the first sensor data; and
instructing, by the data processing hardware, traversal of the set of stairs by the robot based on mapping the set of stairs.

2. The method of claim 1, wherein instructing the performance of the stair mapping maneuver comprises:
instructing adjustment of a field of view of the robot.

3. The method of claim 1, wherein instructing the performance of the stair mapping maneuver comprises:
identifying a location within the environment associated with the set of stairs based on the map; and
instructing movement by the robot to the location.

4. The method of claim 1, wherein instructing the performance of the stair mapping maneuver comprises:
instructing movement by the robot to a location within the environment; and
instructing adjustment of one or more of an orientation of the robot, a position of the robot, or a pose of the robot based on instructing movement by the robot to the location within the environment.

5. The method of claim 1, wherein instructing the performance of the stair mapping maneuver comprises:
determining an orientation of the robot with respect to the set of stairs; and
instructing the performance of the stair mapping maneuver based on the orientation of the robot with respect to the set of stairs.

6. The method of claim 1, wherein instructing the performance of the stair mapping maneuver comprises:
predicting, using second sensor data associated with the environment, a field of view of a sensor at a location within the environment includes the set of stairs; and
instructing movement by the robot to the location.

7. The method of claim 1, wherein instructing the performance of the stair mapping maneuver comprises:
determining, using second sensor data associated with the environment, a location within the environment to view the set of stairs;
instructing movement by the robot to the location; and
verifying the movement by the robot to the location,
wherein obtaining the first sensor data comprises:
obtaining the first sensor data based on verifying the movement by the robot to the location.

8. The method of claim 1, wherein instructing the performance of the stair mapping maneuver comprises:
determining, using second sensor data associated with the environment, one or more of a pose of the robot, a position of the robot, or an orientation of the robot; and
instructing adjustment of the robot based on determining the one or more of the pose, the position, or the orientation,
wherein obtaining the first sensor data comprises:
obtaining the first sensor data based on instructing adjustment of the robot.

9. The method of claim 1, wherein instructing the performance of the stair mapping maneuver comprises:
instructing movement of a leg of the robot;
obtaining second sensor data; and
determining that the leg contacts a portion of the set of stairs based on the second sensor data, wherein mapping the set of stairs is further based on the second sensor data.

10. The method of claim 1, wherein instructing the performance of the stair mapping maneuver comprises:
adjusting at least one of a speed of the robot, a gait of the robot, or a swing of a leg of the robot.

11. The method of claim 1, wherein instructing the performance of the stair mapping maneuver comprises:
instructing iterative performance of a hierarchical plurality of stair mapping maneuvers.

12. The method of claim 1, wherein instructing the performance of the stair mapping maneuver comprises:
adjusting a stair mapping maneuver for performance by the robot from a first stair mapping maneuver to a second stair mapping maneuver, wherein a first portion of the set of stairs are occluded with respect to a field of view of a sensor of the robot based on performance of the first stair mapping maneuver, wherein a second portion of the set of stairs are occluded with respect to the field of view based on performance of the second stair mapping maneuver, wherein a first portion of the first sensor data is based on the performance of the first stair mapping maneuver and a second portion of the first sensor data is based on the performance of the second stair mapping maneuver.

13. The method of claim 1, further comprising:
adjusting a manner of navigation of the robot based on mapping the set of stairs,
wherein instructing traversal of the set of stairs comprises:
instructing traversal of the set of stairs by the robot based on the adjusted manner of navigation.

14. The method of claim 1, wherein instructing the performance of the stair mapping maneuver comprises:
instructing the performance of a first stair mapping maneuver;
determining that at least a portion of the set of stairs are occluded with respect to a field of view of a sensor of the robot based on the first stair mapping maneuver; and
instructing performance of a second stair mapping maneuver based on determining that the at least a portion of the set of stairs are occluded.

15. The method of claim 1, wherein instructing the performance of the stair mapping maneuver comprises:
instructing performance of a first stair mapping maneuver,
the method further comprising:
mapping a first portion of the set of stairs based on the performance of the first stair mapping maneuver;
instructing performance of a second stair mapping maneuver based on mapping the first portion of the set of stairs; and
mapping a second portion of the set of stairs based on the performance of the second stair mapping maneuver, wherein different portions of the set of stairs are mapped based on the performance of the first stair mapping maneuver and the performance of the second stair mapping maneuver.

16. The method of claim 1, further comprising:
generating a first stair model based on performance of a first stair mapping maneuver, wherein the first stair model maps a first portion of the set of stairs to the first sensor data;
determining that the first stair model does not satisfy a threshold; and
adjusting a stair mapping maneuver for performance by the robot from the first stair mapping maneuver to a second stair mapping maneuver based on determining that the first stair model does not satisfy the threshold,
wherein mapping the set of stairs comprises:
generating a second stair model based on performance of the second stair mapping maneuver, wherein the second stair model maps a second portion of the set of stairs to second sensor data; and
determining that the second stair model satisfies the threshold.

17. The method of claim 1, wherein mapping the set of stairs comprises:
mapping the set of stairs based on the performance of the stair mapping maneuver,
the method further comprising:
determining a confidence metric associated with mapping the set of stairs; and
verifying that the confidence metric satisfies a threshold.

18. The method of claim 1, further comprising:
identifying at least one of a mission or a navigation route associated with the robot; and
determining that the at least one of the mission or the navigation route is associated with the set of stairs,
wherein instructing the performance of the stair mapping maneuver comprises:
instructing the performance of the stair mapping maneuver further based on determining that the at least one of the mission or the navigation route is associated with the set of stairs.

19. A system comprising:
data processing hardware; and
memory in communication with the data processing hardware, the memory storing instructions that when executed on the data processing hardware cause the data processing hardware to:
obtain a map of an environment of a robot;
determine, based on the map, that the environment comprises a set of stairs;
instruct performance of a stair mapping maneuver by the robot based on determining that the environment comprises the set of stairs;
obtain first sensor data based on the performance of the stair mapping maneuver;
map the set of stairs based on the first sensor data; and
instruct traversal of the set of stairs by the robot based on mapping the set of stairs.

20. The system of claim 19, wherein to instruct the performance of the stair mapping maneuver, execution of the instructions on the data processing hardware further causes the data processing hardware to:
instruct a deviation by the robot from a route edge connecting a first route waypoint and a second route waypoint.

21. The system of claim 19, wherein execution of the instructions on the data processing hardware further causes the data processing hardware to:
select the stair mapping maneuver from a set of stair mapping maneuvers based on a cost function, wherein each stair mapping maneuver of the set of stair mapping maneuvers indicates one or more of a respective orientation or a respective position.

22. The system of claim 19, wherein execution of the instructions on the data processing hardware further causes the data processing hardware to:
obtain second sensor data from a sensor of the robot,
wherein to instruct the performance of the stair mapping maneuver, the execution of the instructions on the data processing hardware further causes the data processing hardware to:
instruct the performance of the stair mapping maneuver further based on the second sensor data.

23. A robot comprising:
data processing hardware; and
memory in communication with the data processing hardware, the memory storing instructions that when executed on the data processing hardware cause the data processing hardware to:
obtain a map of an environment of the robot;
determine, based on the map, that the environment comprises a set of stairs;
instruct performance of a stair mapping maneuver by the robot based on determining that the environment comprises the set of stairs;
obtain first sensor data based on the performance of the stair mapping maneuver;
map the set of stairs based on the first sensor data; and
instruct traversal of the set of stairs by the robot based on mapping the set of stairs.

24. The robot of claim 23, wherein to map the set of stairs, execution of the instructions on the data processing hardware further causes the data processing hardware to:
generate a stair model based on the performance of the stair mapping maneuver,
wherein the execution of the instructions on the data processing hardware further causes the data processing hardware to:
determine one or more criteria associated with the set of stairs; and
verify that the stair model satisfies the one or more criteria, wherein instructing traversal of the set of stairs is further based on verifying that the stair model satisfies the one or more criteria.

25. The robot of claim 23, wherein to instruct the performance of the stair mapping maneuver, execution of the instructions on the data processing hardware further causes the data processing hardware to:
adjust a stair mapping maneuver for performance by the robot from a first stair mapping maneuver to a second stair mapping maneuver.

26. The robot of claim 23, wherein to map the set of stairs, execution of the instructions on the data processing hardware further causes the data processing hardware to:
generate a stair model; and
determine the stair model maps a riser of the set of stairs to the first sensor data,
wherein instructing traversal of the set of stairs is based on determining the stair model maps the riser of the set of stairs to the first sensor data.
